(19) United States
(12) Patent Application Publication
(10) Pub. No.: US 2006/0098735 A1
(43) Pub. Date: May 11, 2006

(54) Apparatus for motion estimation using a two-dimensional processing element array and method therefor

(76) Inventor: Yu-Chung Chang, Taipei City (TW)

Correspondence Address: RABIN & Berdo, PC, 1101 14TH STREET, NW, SUITE 500, WASHINGTON, DC, 20005, US

(21) Appl. No.: 10/984,935

(22) Filed: Nov. 10, 2004

(51) Int. Cl. H04N 7/12; H04N 11/04; H04B 1/66; H04N 11/02

(52) U.S. Cl. 375/240.12; 375/240.24

(57) ABSTRACT

An apparatus for motion estimation and method therefor are provided. The apparatus includes a processing element (PE) array unit that includes a delay unit array and a PE array. The delay unit array outputs different data flows of current data to the PE array with respect to checking points in one step of an N-step seach algorithm, while a regular data flow of reference data is fed into the PE array. One search step of the N-step search algorithm for motion estimation can be performed while the pixel data of a search area is read in a regular pixel scan order. When the search area is read completely, the search step is completed. In this way, the PE array unit achieves the N-step search algorithm. Further, the PE array unit can be configured to perform half-pel motion estimation with respect to a best point found in a full-pel search.

### BACKGROUND OF THE INVENTION

1. Field of the Invention

The invention relates in general to an apparatus for motion estimation and method therefor, and more particularly to an apparatus for motion estimation using a two-dimensional processing element array and a method therefor.

2. Description of the Related Art

Video compression or video encoding is essential to a variety of multimedia applications in electronic devices. Motion estimation is one of the key elements to video compression. MPEG-4, for example, one of the mainstream video compression standards, is widely employed in a variety of applications and devices ranging from high-bit-rate, high quality video devices, such as high definition television (HDTV) or digital versatile disk (DVD) player, to low-bit-rate mobile processing devices, such as mobile phone or digital personal assistant (PDA), with video capability. During MPEG-4 video encoding, motion estimation consumes relatively a large amount of computation time and most of the system resources. For MPEG-4 video encoding, about 60 to 80% of the computation time is consumed in motion estimation. With regard to computation loading and resource usage, motion estimation is a critical factor to implement MPEG-4 encoders in processing devices, particularly in mobile processing devices, which typically have limited resources including limited power capacity, limited memory resource, and limited processing power.

Complexity of the encoders for video compression is dominated by motion estimation. Employing temporal redundancy of adjacent frames in a video sequence, motion estimation is aimed to find a motion vector by which a current macroblock in a current frame can be predicated from a reference macroblock in a reference frame, where the reference macroblock has a minimum error measure as compared with the current macroblock. Many block matching algorithms (BMAs) for motion estimation have been developed for performance improvement and/or reduced hardware complexity. Among the BMAs, step search algorithms, such as three step search (TSS), or four step search (4SS), are developed to reduce computation redundancy and improve performance. However, the data flow employed in these search algorithms are irregular so that hardware implementation of the algorithms is complex. Besides, the overall performance of a processing device performing the step search algorithm cannot achieve the theoretic performance of the algorithm in view of limited resources provided by the processing device, particularly crucially to the mobile processing device.

Many architectural solutions for implementing BMA can be found in the literature. For example, Costa et al., “A VLSI Architecture For Hierarchical Motion Estimation”, IEEE Transactions on Consumer Electronics, Vol. 41, No. 2, May 1995, pp. 248-257, and Kim et al., “A Fast Motion Estimator for Real-Time System”, IEEE Transactions on Consumer Electronics, Vol. 43, No. 1, February 1997, pp. 24-33, proposed hardware architecture based on the TSS algorithm and concentrated on data flow within processing element (PE) array. However, data flows within the PE array employed in these hardware architectures are complex and dedicated to the TSS, causing some problems outside the PE array.

First, complex data flow within the PE array results in complex implementation of the PE array control circuit. Secondly, complex data flow within the PE array inherently leads to repetition of memory read operations for the pixel data during motion estimation. In a typical encoder, a memory bus coupled to the motion estimation architecture and frame memory and other units of the encoder will be busy for those repeated read operations for the pixel data, and the overall performance would thus be degraded. Although this problem can be straightforwardly resolved by providing additional pixel data memory blocks for buffering pixel data from the frame memory and loading the required pixel data into the memory blocks before each search step of the TSS algorithm, overall performance of motion estimation would still be reduced and higher hardware cost for memory is required. In addition, elaborate design of data flow dedicated to the TSS algorithm hinders the utilization of the architectures for other step search algorithms, such as the FSS algorithm. With respect to a limited resource environment, such as mobile processing devices, the above described problems outside the PE array are crucial to hardware implementation and must be carefully considered in order to make the device successful and possible for end users of the devices.

Therefore, it is desirable to provide a motion estimation architecture to resolve the above described problems and to provide expandability and flexibility in view of circuit design.

### SUMMARY OF THE INVENTION

It is therefore an object of the invention to provide an apparatus for motion estimation with a two-dimensional processing element (2D PE) array and a method therefor. According to the invention, a data flow scheme for within the PE array is provided to reduce hardware complexity of the control hardware of the 2D PE array. With the data flow scheme, number of times of memory access is reduced and a reduced computation time can be achieved, thereby achieving less power consumption. The 2D PE array can also benefit from its structure and the data flow scheme. Control of the 2D PE array is regular and simple, and a reduced circuit area for the motion estimation system is achieved. A motion estimation system using the 2D PE array unit is therefore suitable for a mobile processing device, such mobile phone or PDA, which is with a limited power supply.

According to one of the objects of the invention, an apparatus for motion estimation is provided to include a processing element (PE) array unit. The PE array unit includes a delay unit array and a processing element (PE) array. The delay unit array includes a plurality of horizontal delay units (HDUs) and a plurality of vertical delay units (VDUs). There are 3 rows of HDUs, each row having a first HDU and a second HDU, each HDU including an input terminal and an output terminal, wherein in each row, the output terminal of the first HDU is connected to the input terminal of the second HDU. There are a first VDU and a second VDU, each having an input terminal and an output terminal, wherein the input terminal of the first VDU is connected to the input terminal of the first HDU of the first row, the output terminal of the first VDU is connected to the input terminal of the first HDU of the second row and the input terminal of the second VDU, the output terminal of the second VDU is connected to the input terminal of the first HDU of the third row. The PE array includes 3 rows of processing elements (PEs), each row having first, second, and third PEs, each PE including a first input terminal and a second input terminal, an error measure output terminal, and a control terminal. In each row, the second input terminal of the first PE is connected to the input terminal of the first HDU; the second input terminal of the second PE is connected to the output terminal of the first HDU; the second input terminal of the third PE is connected to the output terminal of the second HDU; wherein each PE calculates an error measure accumulatively between reference data at the first input terminal and pixel data at the second input terminal when the control terminal is enabled.

In one embodiment, the PE array unit is configured to perform a search step of N-step search algorithm for motion estimation while the pixel data of the pixels in a search area is reading in a regular pixel scan order, wherein a number of macroblocks of the search area are compared to a current macroblock in parallel. When the reading of the search area is completed, the search step is completed and a minimum error measure can be determined.

In one embodiment, a configuration of the 2D PE array unit for performing full-pel motion estimation is provided to perform FSS algorithm for motion estimation in a second embodiment of the invention.

According to one of the objects of the invention, a method for full-pel motion estimation is provided. A search step of N-step search algorithm for motion estimation is completed while the pixel data of the pixels in a search area is reading in a regular pixel scan order, wherein a number of macroblocks of the search area are compared to a current macroblock in parallel.

In another embodiment of the invention, a motion estimation system architecture is shown by which motion estimation is achieved and integrated in a circuit.

Based on the configuration of the motion estimation method, regular data flows from a current memory and a reference memory are in a sequential, line after line, manner and control circuit for controlling the PE array unit can thus be implemented in a simplified manner.

According to other object of the invention, the 2D PE array unit is expandable and flexible in design and can be further utilized to perform motion vector refinement with fractional pixel accuracy, such as half-pel or quarter-pel motion estimation.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram illustrating a two-dimensional processing element (2D PE) array unit according to a first embodiment of the invention.

FIG. 2 illustrates an example of one of the processing elements in the 2D PE array unit according to the invention.

FIG. 3 illustrates an example of one of the horizontal delay units (HDUs) in the 2D PE array according to the invention.

FIG. 4 illustrates an example of one of the vertical delay units (VDUs) in the 2D PE array unit according to the invention.

FIG. 5 shows a configuration of the 2D PE array unit for performing full-pel motion estimation according to a second embodiment of the invention.

FIG. 6A shows a macroblock in a current frame and a search area in a previous frame, known as a reference frame.

FIG. 6B illustrates the nine search positions per step in the four step search for full-pel motion estimation.

FIG. 7 illustrates a pixel scan order in which luminance data of pixels in the search area is scanned according to the invention.

FIG. 8 illustrates processing element (PE) enabling cycles corresponding to sub-areas of the search area according to the second embodiment of the invention.

FIG. 9 is a block diagram illustrating a full-pel motion estimation system using a 2D PE array unit according to a third embodiment of the invention.

FIG. 10 illustrates a half-pel search around a best point found in a full-pel search.

FIG. 11A is a diagram illustrating a preparation delay unit for outputting four full-pel values in parallel.

FIG. 11B illustrates a half-pel generating circuit for converting four full-pel values into four half-pel values.

FIG. 12 shows a configuration of the 2D PE array unit for performing half-pel motion estimation according to a fourth embodiment of the invention.

FIGS. 13A and 13B illustrate processing element (PE) enabling cycles corresponding to sub-areas of the search area according to the fourth embodiment of the invention.

FIG. 14 is a block diagram illustrating a motion estimation system for performing full-pel and half-pel motion estimation using a 2D PE array unit according to a fifth embodiment of the invention.

### DETAILED DESCRIPTION OF THE INVENTION

A two-dimensional processing element (2D PE) array unit is provided in a first embodiment of the invention. This array unit can be configured to perform a search step of N-step search algorithm for motion estimation while the pixel data of the pixels in a search area is reading in a regular pixel scan order, wherein a number of macroblocks of the search area are compared to a current macroblock in parallel. A configuration of the 2D PE array unit for performing full-pel motion estimation is provided to perform FSS algorithm for motion estimation in a second embodiment of the invention. Notably, 9 macroblocks of the search area are compared to a current macroblock in parallel while the pixel data of the pixels in a search area is being read in a pixel scan order according to the invention. Based on the configuration, regular data flows from a current memory and a reference memory are designed and control circuit for controlling the PE array unit can be implemented in a simplified manner. In a third embodiment of the invention, a motion estimation system architecture is shown by which motion estimation is achieved and integrated in a circuit. The 2D PE array unit is expandable and flexible in design. In other embodiments, the 2D PE array can be further utilized to perform half-pel motion estimation.

Two-Dimensional processing Element (2D PE) Array Unit

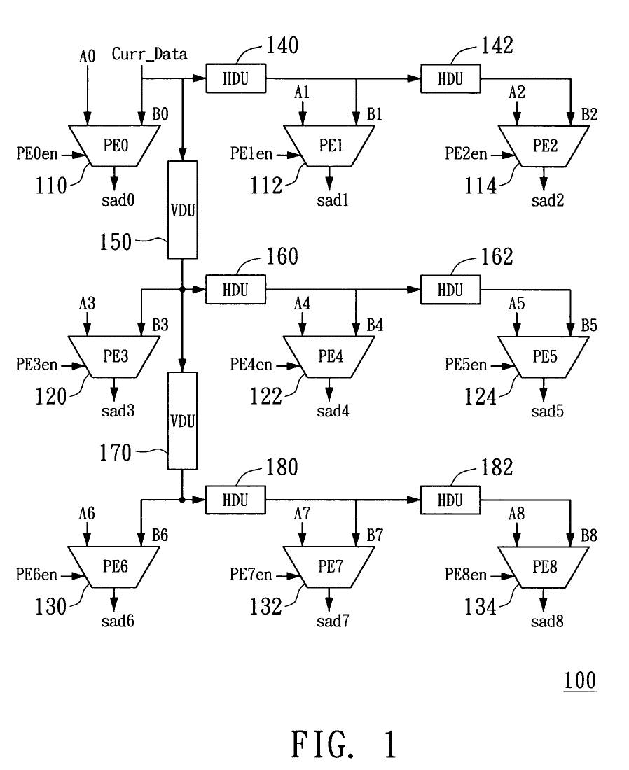

Referring to FIG. 1, a two-dimensional processing element (2D PE) array unit 100 is illustrated according to a first embodiment of the invention for motion estimation. The processing element (PE) array unit 100 includes a delay unit array and a processing element array. The PE array has 3 rows of PEs, and each row has first, second, and third PEs. Thus, there are totally 9 PEs in this PE array. Specifically, each PE includes a first input terminal, a second input terminal, an error measure output terminal, and a control terminal. For example, PE0 includes a first input terminal A0, a second input terminal B0, an error measure output terminal sad0 (e.g. the error measure is the sum of absolute differences (SAD)), and a control terminal PE0en. The delay unit array includes a plurality of horizontal delay units (HDUs) and a plurality of vertical delay units (VDUs). It is noted that the second input terminals, B0 to B8, of the PE array are respectively connected to the delay unit array in order to form the 2D PE array unit.

In FIG. 1, there are 3 rows of HDUs, each row has a first HDU and a second HDU, and each HDU includes an input terminal and an output terminal, wherein in each row, the output terminal of the first HDU is connected to the input terminal of the second HDU. Specifically, there are HDU 140 and HDU 142 in the first row, and the output terminal of the HDU 140 is connected to the input terminal of the HDU 142. In the second row, HDU 160 and HDU 162 are present, and the output terminal of the HDU 160 is connected to the input terminal of the HDU 162. In the third row, HDU 180 and HDU 182 are present, and the output terminal of the HDU 180 is connected to the input terminal of the HDU 182. In addition, the vertical delay units (VDUs) includes a first VDU 150 and a second VDU 170 and each VDU has an input terminal and an output terminal. The input terminal of the first VDU 150 is connected to the input terminal of the first HDU 140 of the first row; the output terminal of the first VDU 150 is connected to the input terminal of the first HDU 160 of the second row and the input terminal of the second VDU 170; and the output terminal of the second VDU 170 is connected to the input terminal of the first HDU 180 of the third row.

The connection between the PE array and the delay unit array is illustrated in FIG. 1 according to the first embodiment of the invention. In each row of the PE array, the second input terminal of the first PE is connected to the input terminal of the first HDU; the second input terminal of the second PE is connected to the output terminal of the first HDU; and the second input terminal of the third PE is connected to the output terminal of the second HDU. In the first row of the PE array, the second input terminal B0 of the first PE 110 (PE0) is connected to the input terminal of the first HDU 140; the second input terminal B1 of the second PE 112 (PE1) is connected to the output terminal of the first HDU 140; and the second input terminal B2 of the third PE 114 (PE2) is connected to the output terminal of the second HDU 142. In the second row of the PE array, the second input terminal B3 of the first PE 120 (PE3) is connected to the input terminal of the first HDU 160; the second input terminal B4 of the second PE 122 (PE4) is connected to the output terminal of the first HDU 160; and the second input terminal B5 of the third PE 124 (PE5) is connected to the output terminal of the second HDU 162. In the third row of the PE array, the second input terminal B6 of the first PE 130 (PE6) is connected to the input terminal of the first HDU 180; the second input terminal B7 of the second PE 132 (PE7) is connected to the output terminal of the first HDU 180; and the second input terminal B8 of the third PE 134 (PE8) is connected to the output terminal of the second HDU 182. Each PE is used for accumulatively calculating a specific-type of error measure between reference data at the first input terminal of the PE and pixel data at the second input terminal of the PE when the control terminal is enabled.

The 2D PE array unit shown in FIG. 1 can be configured to perform full-pel motion estimation. One of the search steps of an N-step search algorithm for motion estimation is being performed while the pixel data of the pixels in a search area is being read in a regular pixel scan order and applied to the 2D PE array unit. When the search area is scanned completely and corresponding pixel data is fed into the 2D PE array unit completely, comparisons of a number of macroblocks of the search area (corresponding to specified checking points) with a current macroblock are done in parallel, resulting in corresponding error measures corresponding to the checking points. A checking point with the minimum error measure can then be determined according to the obtained error measures. That is, one search step of N-step search algorithm for motion estimation can be performed by the 2D PE array unit during a scanning of the search area. Any N-step search algorithm for motion estimation can therefore be performed using the 2D PE array unit.

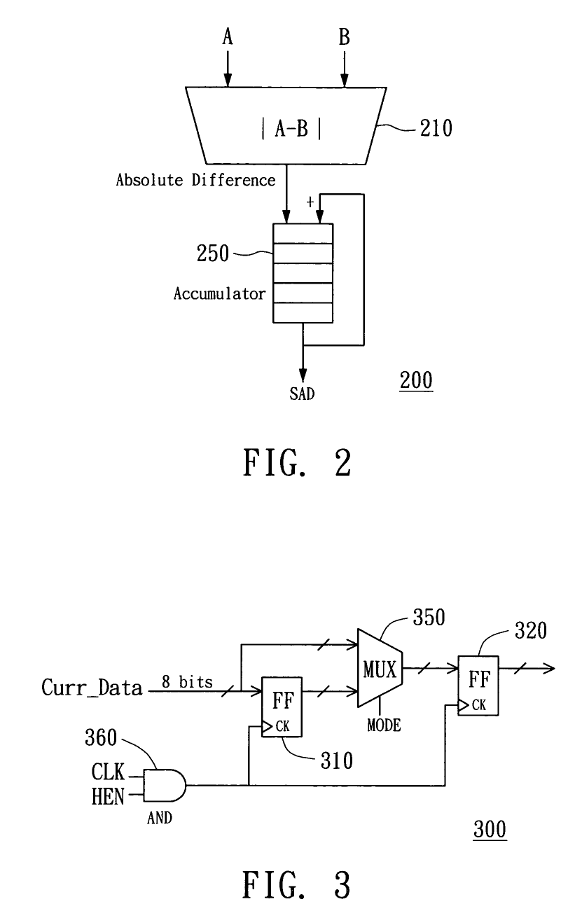

In practical applications, a specified error measure is chosen to be performed in implementing the 2D PE array unit. Any error measures, for example, sum of absolute differences (SAD), mean squared error (MSE), or mean absolute error (MAE), can be adopted in the 2D PE array unit, and one or some of error measure schemes can be embedded or used in the 2D PE array unit selectively. Preferably, SAD is adopted in the following embodiments for sake of illustration. Referring to FIG. 2, an example of a processing element 200 for performing SAD between data at a first input terminal A and a second input terminal B is illustrated. The PE 200 includes a absolute difference device 210 and an accumulator 250. By synchronously and correspondingly applying pixel values of a reference macroblock and a current macroblock sequentially to the absolute difference device 210, SAD can be determined using the accumulator 250 according to the equation (for example, with respect to the current macroblock of 16×16 pels):

$$SAD = {\sum }_{x = 0 ∼ 15 , y = 0 ∼ 15} \vert {Ref\_Data}_{x , y} - {Curr\_Data}_{x , y} \vert .$$

Configuration of the 2D PE Array Unit for Performing Full-Pel Motion Estimation

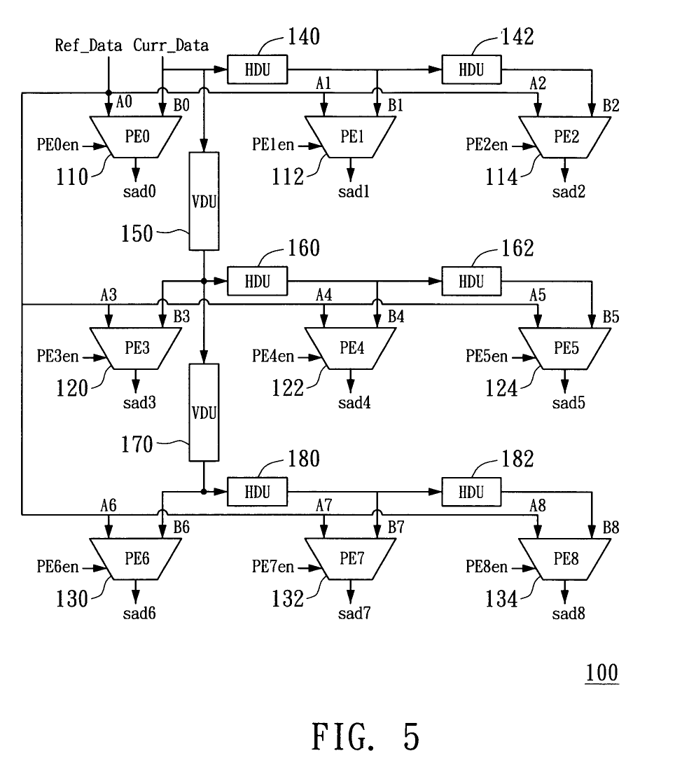

Referring to FIG. 5, a configuration of the 2D PE array unit for performing full-pel motion estimation is shown according to a second embodiment of the invention. Notably, the first input terminals of all PEs are connected together so that reference data applied to the 2D PE array unit is synchronously applied to the first input terminals of all PEs. Meanwhile, when current data is applied to both the second input terminal B0 of the first PE 110 (PE0) and the input terminal of the first HDU 140 in the first row, the delay unit array produces 8 different data flows with specific delay times to the respective second input terminals of the PEs. In the second embodiment, reference data of a search area is sequentially read and synchronously applied to the first input terminal of each PE while current data of a macroblock is sequentially read and applied to the second terminal of each PE in a way such that each PE correctly performs an error measure, such as SAD, between a specific reference macroblock in a search area and the current macroblock. In order to fulfil the requirements, pixel scan order, the delay unit array, and the control of the PE array are required to be specified with respect to a step search algorithm for motion estimation to be performed by the 2D PE array unit.

Four Step Search Algorithm

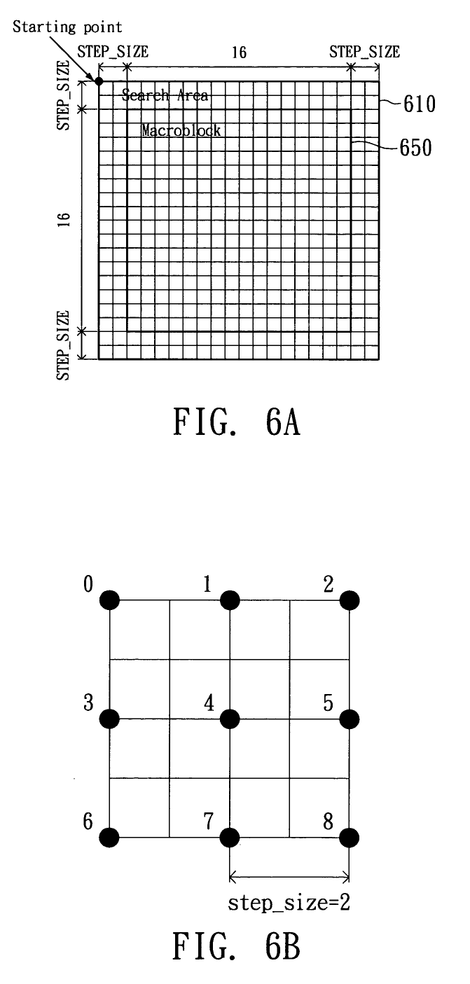

In this embodiment, the four step search (FSS) algorithm for motion estimation is to be performed by the 2D PE array unit in FIG. 5. FSS algorithm was described in “A Novel Four Step Search Algorithm for Fast Block Motion Estimation”, by Po et al., IEEE Transactions on Circuits and Systems for Video Technology, vol. 6, no. 3, June 1996, pp. 313-317; incorporated herein by reference. According to this article, FSS algorithm utilizes a center-biased search pattern with nine checking points on a 5×5 window in the first step, as illustrated in FIG. 6B, wherein the step size (STEP_SIZE), which is the distance from one checking point to the next checking point in the search pattern, is 2. The center of the search window is then shifted to the point with minimum block distortion measure (BDM). The search window size of the next two steps depended on the location of the minimum BDM points. If the minimum BDM point is found at the center of the search window, the search will go to the final step (Step 4) with 3×3 search window. Otherwise, the search window size is maintained in 5×5 for step 2 or step 3. In the final step, the search window is reduced to 3×3 and the search stops at this small search window, wherein the step size is reduced to 1.

In the FSS algorithm, a step indicates a search for a minimum BDM point within a search area. In practical applications, a current memory is required to store pixel data of a frame currently to be decoded, and a reference memory is employed to store pixel data of a reconstructed frame obtained by decoding a previous decoded frame, wherein the reconstructed frame is used as a reference frame for the current frame to be decoded. In the reference memory, the pixel data, called reference data (Ref_Data), corresponding to a pixel in the reconstructed frame is a luminance pixel value of 8 bits. In the current memory, the pixel data, called current data (Curr_Data), corresponding to a pixel in the current frame is a luminance pixel value of 8 bits. In one step, a search area, as shown in FIG. 6A, is a data area of the reference memory that is required to be read, wherein a macroblock (in MPEG-4) is of 16×16 pels and search area=x_range·y_range, x_range=16+STEP_SIZE×2, and y_range=16+STEP_SIZE×2. In FIG. 6B, nine checking points are shown on a 5×5 window in the first step, and a number corresponding to each checking points indicates the order of the search position. The point 0 in FIG. 6B defines the starting point, also shown in FIG. 6A, of the search per step. After that, the point 1 represents the next checking point (corresponding to a reference macroblock) for calculating a error measure. The point 8 is the last checking point.

Pixel Scan Order

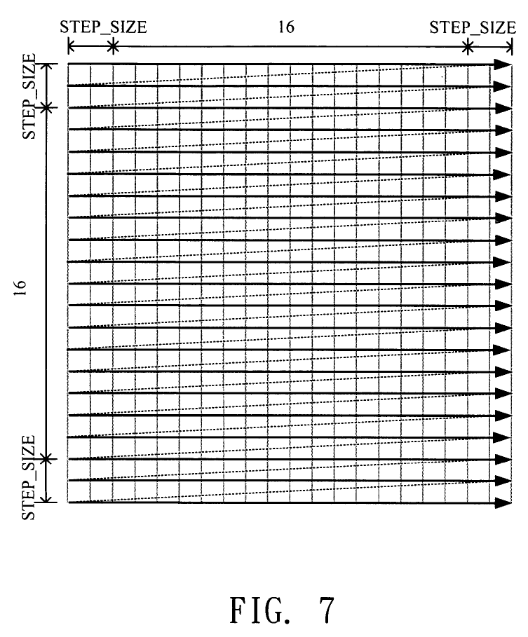

Referring to FIG. 7, pixel scan order for the search area is illustrated according to the second embodiment of the invention. The reference data of the search area in a step is being read sequentially, line after line, from the starting point, denoted by R(0, 0), to the ending point of the search area, denoted by R(x_range−1, y_range−1).

Likewise, the pixel scan order for the current macroblock, or the reading of pixel value of the current macroblock, is sequential, pixel by pixel, line after line. If PE0 is enabled, i.e. when the enabling signal applied to the control terminal PE0en of PE0 indicates “enabled”, the pixel values of the current macroblock are read in the pixel scan order for the current macroblock. In one embodiment, when PE0 is enabled, a piece of current data is read immediately before a piece of reference data is read. In FIG. 5, the PEs determine the error measures, e.g. SADs in this embodiment, corresponding to the checking points shown in FIG. 6B in a step of FSS algorithm. For example, PE0 is used for comparing the current macroblock to a reference macroblock associated with checking point (0, 0) using the error measure, wherein the checking point is in the upper left corner of the reference macroblock. PE4, for example, is used for comparing the current macroblock to a reference macroblock associated with checking point (STEP_SIZE, STEP_SIZE), for example (2, 2) in FIG. 6B. With regard to this functionality of PE, Ref_Data and Curr_Data should be correctly, for example, synchronously applied to the PE array in order to make each PE determine the error measure, i.e. SAD, corresponding to the checking point. For instance, with respect to PE0, an absolute difference is obtained correctly when a pixel value of pixel (0, 0) of the search area and that of pixel (0, 0) of the macroblock are synchronously applied to the first input terminal A0 and second input terminal B0, respectively. The other PEs have pixel values inputted correctly by the help of the delay unit array. With respect to PE0, after the pixel value (Curr_Data) of the last pixel in a row of the current macroblock is read and applied to the second input terminal B0, PE0 is disabled. In this time, the scanning of the search area continues but the scanning of the current macroblock pauses until the first pixel of the next row of the search area is scanned. When the first pixel of the next row of the search area is to be scanned, PE0 is enabled again and the scanning of the current macroblock continues. In this way, the pixel value of the next row of the current macroblock and that of the next row of the search area can be correctly, e.g. synchronously, applied to PE0. The scanning of the current macroblock is done in the above manner so that the other PEs can receive correct pixel values for determining error measures, correspondingly.

Delay Unit Array

The scanning of the search area and that of the current macroblock are similarly in a sequential, pixel by pixel, line after line manner. In the second embodiment, while the scanning of the search area is completed, 9 error measures associated with 9 checking points are determined as well as the MBDM in the step. With the pixel scan order for the current macroblock above described, the delay unit array provides 8 different data flows with specific delay times to the respective second input terminals of the PEs in order that the pixel values from the search area and those from the output terminals of the delay unit array are correctly fed into the PEs.

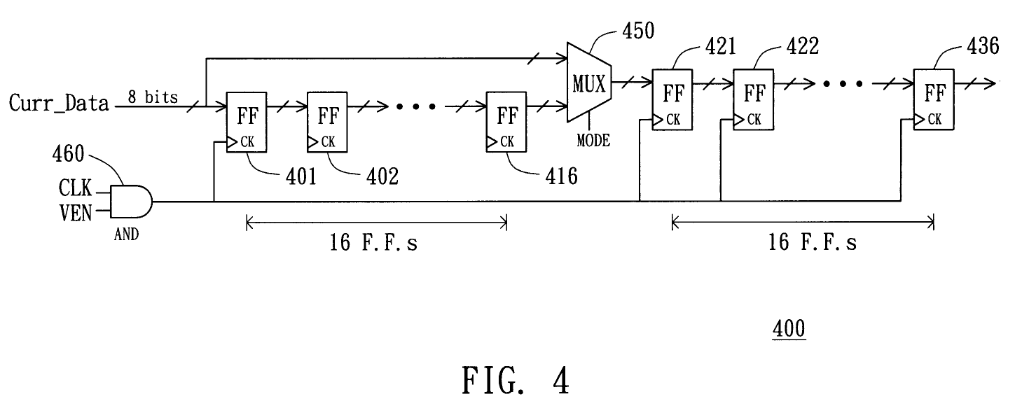

In the FSS algorithm, step size is 2 in the first, second, and third steps, and step size changes to 1 in the final step. Each of the HDUs has a delay time of STEP_SIZE time units while each of the VDUs has a delay time of STEP_SIZE×P, wherein P is the width (number of pixels) of the macroblock, and P=16 in the embodiment. Referring to FIG. 3, an example of a HDU 300 is illustrated to output Curr_Data of 8 bits after one or two time units selectively. The HDU 300 includes two flip-flops (FFs) 310 and 320, a multiplexer 350, and an AND logic gate 360, wherein the FFs are clock gating cells. The HDU 300 can output Curr_Data of 8 bits after one or two time units selectively by using a selection input terminal (MODE) of the multiplexer 350. Referring to FIG. 4, an example of a VDU 400 is illustrated to output Curr_Data of 8 bits after 16×1 or 16×2 time units (cycles) selectively. The VDU 400 includes 32 FFs, namely FF 401 to FF 416, FF 421 to FF 436, one multiplexer 450, and an AND logic gate 460, wherein the FFs are clock gating cells. The VDU 400 can output Curr_Data of 8 bits after 16×1 or 16×2 time units (cycles) selectively by using a selection input terminal (MODE) of the multiplexer 450. Thus, by applying a control signal to the selection input terminals of the multiplexers of the HDUs and VDUs of the delay unit array, the delay unit array can provide 8 different data flows with specific delay times to the respective second input terminals of the PEs in order that the pixel values of the search area and the pixel values of the current macroblock are synchronously fed into the PEs. When the step size is changed in the next step of the step search algorithm, the delay units have respective delay times properly by applying a signal indicative of enabling to MODE.

For example, in the first step of the FSS algorithm, step size is 2. Take PE1 as example. PE1 is responsible for determining the error measure between the current macroblock and the macroblock in the search area with a starting point at (2,0) of the search area. Thus, PE1 is enabled when Ref_Data corresponding to (2, 0) to (17, 0) of the search area is sequentially fed into the first input terminal A1 of PE1. At the same time, Curr_Data corresponding to (0, 0) to (15, 0) of the current macroblock is required to be sequentially fed into the second input terminal B1 of PE1. Referring to FIG. 5, the HDU 140 fulfils this requirement by feeding Curr_Data into the second input terminal B1 of PE1 with a delay time of STEP_SIZE, i.e. two time units (cycles). Therefore, while Ref_Data and Curr_Data are correctly and synchronously fed into PE0, Curr_Data after delayed by two cycles and Ref_Data are correctly and synchronously fed into PE1. For the other PEs, such as PE3 and PE8, the operations are done in the similar manner except that the PEs are enabled in different cycles and Curr_data fed into the second input terminals of the PEs are to be delayed for different cycles.

In addition, the HDU and VDU are also called delay lines and can be implemented by another logic circuits. Notably, if a step search algorithm to be performed by the 2D PE array unit has different step sizes during different search step, the number of FFs, for example, of the HDUs and VDUs can be modified according to the requirements for the step search algorithm.

Control of the PE Array

Each PE of the PE array has a control terminal PEZen, where Z indicates a number from 0 to 8. Referring to FIG. 7, the scanning of the search area enables Ref_Data to be fed into the first input terminal of each PE in a regular order while Curr_Data is fed into PE0 and Curr_Data outputted by the delay unit array with specific delay time is fed into the remaining PE, namely PE1 to PE8. With respect to a PE, say PE4, during the scanning of the search area, Ref_Data corresponding to some pixels, for example, from (0, 0) to (1, 15) of the search area, is meaningless to the determination of error measure associated with the checking point (2, 2). Thus, an enabling signal is to control PE4 not to process the Ref_Data that corresponds to pixels that are out of the range of the reference macroblock associated with the checking point (2, 2). For this reason, enable cycles are provided according to the second embodiment of the invention to make the PE array unit operate properly.

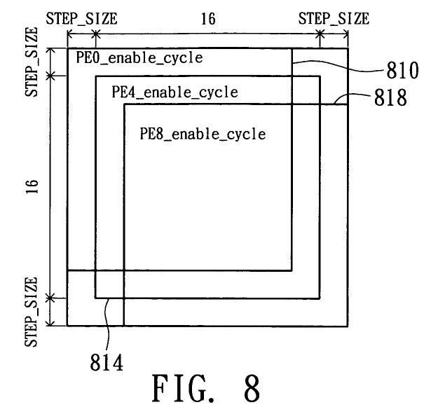

Referring to FIG. 8, PE enable cycle is defined intuitively by subdividing the search area into 9 sub-areas. The search area is divided into a subset of sub-areas of the same size as the current macroblock, associated with an array of checking points (0, 0), (STEP_SIZE, 0), (2×STEP_SIZE, 0), (0, STEP_SIZE), (STEP_SIZE, STEP_SIZE), (2×STEP_SIZE, STEP_SIZE), (0, 2×STEP_SIZE), (STEP_SIZE, 2×STEP_SIZE), and (2×STEP_SIZE, 2×STEP_SIZE) respectively, each sub-area in the subset of sub-areas having a starting point defined as the respective checking point. In FIG. 8, PE0_enable-cycle, PE4_enable_cycle, PE8_enable_cycle are shown by the squares 810, 814, 818, respectively, and are associated with the checking points (0, 0), (2, 2), (4, 4), respectively. With the definition of enabling cycle, the control of the PE array is convenient and the implementation is less complexity. For example, a control logic circuit can be implemented to determine which one of the sub-areas includes a pixel, R(i, j), corresponding to Ref_Data in the search area. For each sub-area that is determined to include the pixel R(i, j), a corresponding one of the enabling signals is enabled and applied to the corresponding control terminal of the PE that corresponds to the corresponding checking point.

For example, when Ref_Data corresponds to (2, 2) is read, the control logic circuit determines that PE0_enable_cycle, PE1_enable_cycle, PE3_enable_cycle, and PE4_enable_cycle, (4 sub-areas) include pixel (2, 2). For the 4 sub-areas that are determined to include pixel (2, 2), enabling signals, i.e. PE0_Enable, PE1_Enable, PE3_Enable, PE4_Enable, are enabled and applied to the corresponding control terminals, i.e. PE0en, PE1en, PE3en, PE4en, of the PEs that corresponds to the corresponding checking point, i.e. (0, 0), (2, 0), (0, 2), (2, 2).

Consistent with the second embodiment for performing the FSS algorithm, TABLE 1 lists enabling conditions for the 9 PEs specifically. TABLE 1 specifies the conditions that enable the enabling signals, denoted by PEZ_Enable (Z=0 to 8); when Ref_Data corresponding to a pixel (X, Y) of the search area is included in the sub-areas. It should be noted that conditions in the second column of TABLE 1 defines the sub-areas for the first n-1 steps for full-pel motion estimation, while conditions in the third column defines the sub-areas for the final step for full-pel motion estimation. In addition, the enabling signals, PEZ_Enable (Z=0 to 8), in the second embodiment, are fed into the control terminals PEZen (Z=0 to 8), of PE0 to PE8, respectively.

TABLE 1

| | Enabling conditions | |
|---|---|---|
| | | Full-Pel |
| | | Step = n |
| | Full-Pel Step = 1˜n − 1 | (Final step) |
| PE0_Enable | X = 0˜15 | X = 0˜15 |
| | Y = 0˜15 | Y = 0˜15 |
| PE1_Enable | X = step_size˜(15 + step_size) | X = 1˜16 |
| | Y = 0˜15 | Y = 0˜15 |
| PE2_Enable | X = 2 × step_size˜(15 + 2 × step_size) | X = 2˜17 |
| | Y = 0˜15 | Y = 0˜15 |
| PE3_Enable | X = 0˜15 | X = 0˜15 |
| | Y = step_size˜(15 + step_size) | Y = 1˜16 |
| PE4_Enable | X = step_size˜(15 + step_size) | X = 1˜16 |
| | Y = step_size˜(15 + step_size) | Y = 1˜16 |
| PE5_Enable | X = 2 × step_size˜(15 + 2 × step_size) | X = 2˜17 |
| | Y = step_size˜(15 + step_size) | Y = 1˜16 |
| PE6_Enable | X = 0˜15 | X = 0˜15 |
| | Y = 2 × step_size˜(15 + 2 × step_size) | Y = 2˜17 |
| PE7_Enable | X = step_size˜(15 + step_size) | X = 1˜16 |
| | Y = 2 × step_size˜(15 + 2 × step_size) | Y = 2˜17 |
| PE8_Enable | X = 2 × step_size˜(15 + 2 × step_size) | X = 2˜17 |
| | Y = 2 × step_size˜(15 + 2 × step_size) | Y = 2˜17 |

Architecture of a Motion Estimation System

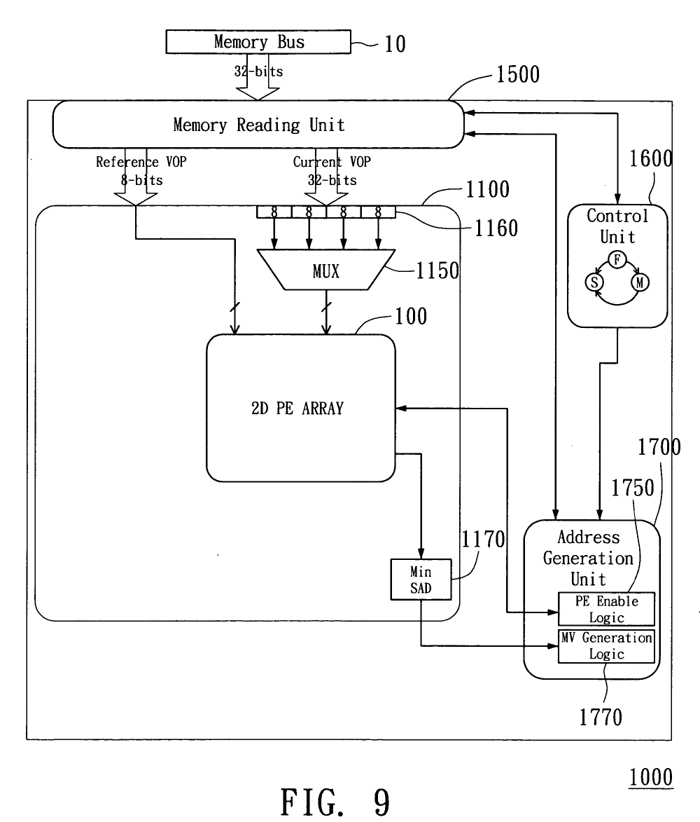

Referring to FIG. 9, a motion estimation system 1000 is provided according a third embodiment of the invention. The motion estimation system 1000 includes a motion estimation unit 1100, a memory reading unit 1500, a control unit 1600, and an address generation unit 1700. FIG. 9 illustrates a system that can output a motion vector for a step-search algorithm, for example the FSS algorithm. The motion estimation system 1000 can be further configured to perform arbitrary N-step search algorithm for motion estimation, for example, the three step search algorithm.

The motion estimation unit 1100 includes a 2D PE array unit 100, a multiplexer 1150, a register unit 1160, and a minimum SAD determination unit 1170.

The memory reading unit 1500 is a memory reading interface for the motion estimation system 1000, wherein the memory reading interface can be implemented to be compliant with at least one communication protocol that is employed by a memory bus 10 coupled to the motion estimation system 1000. The memory bus 10, for example, is coupled to a reference memory and a current memory, and thus the motion estimation system 1000 can read current data and reference data from the current memory and the reference memory via the memory reading unit 1500.

The control unit 1600 is used to count for a step search. The control unit 1600 can be a finite state machine, for example, including two counter circuits, X counter and Y counter, to count for a step search. The X counter counts how many pixels whose pixel value is read in a row of a search area. The Y counter counts how many pixel columns whose pixel values are read in the search area. The X counter increases by one when a piece of Ref_Data, corresponding to a pixel in the search area, is read. The Y counter increases by one when X counter reaches a predetermined value, denoted by X_max_count, and then X counter is reset to 0. When Y counter reaches y_range, the step of the step search algorithm is ended. X_max_count is the width of the search area (number of pixels), i.e. X_max_count=x_range. In step 1 to step n-1 of full-pel motion estimation, X_max_count=x_range=macroblock_size+STEP_SIZE×2. For example, in FSS algorithm, X_max_count=16+2×2=20, where STEP_SIZE=2 except for the final step. For the final step of full-pel motion estimation, X_max_count=x_range but the SIZE_SIZE may be changed to a reduced value. In the final step of the FSS algorithm, X_max_count=16+1×2=18, where STEP_SIZE is 1. The memory reading unit 1500 generates a memory read signal, denoted by Ref_ready, to the control unit 1600. The memory read signal is used to inform the X and Y counters to update their count values. For example, Ref_ready is set to be enabled, e.g. a high level, when a piece of Ref_Data, corresponding a pixel of the search area, is read from a memory, e.g. the reference memory. The PE enabling cycles are determined according to the current count values X and Y from the X and Y counters.

The address generation unit 1700 includes a PE enabling logic circuit 1750 and a motion vector (MV) generation logic circuit 1770. The PE enabling logic circuit 1750 receives the current count values X and Y from the X and Y counters of the counter unit 1600; generates enabling signals according to the current count values X and Y and TABLE 1; and outputs the enabling signals to the 2D PE array unit 100 of the motion estimation unit 1100. As above described, after the scanning of the search area, 9 error measures, e.g. 9 SADs corresponding to the nine checking points in the second embodiment, are obtained, and a minimum error measure is determined and outputted by the minimum SAD determination unit 1170. The address generation unit 1700 receives the minimum error measure outputted by the minimum SAD determination unit 1170. The MV generation logic circuit 1770 generates a motion vector in the final step of the search algorithm. In addition, the address generates unit 1700 generates memory addresses to the memory reading unit 1500 so that reference data and current data are read from the memory reading unit 1500 and fed into the motion estimation unit 1100.

The operation of the motion estimation system 1000 is illustrated to perform an N-step search algorithm for motion estimation. Suppose that the motion estimation system 1000 operates with a clock signal, CLK. First, the 2D PE array unit is configured, as shown in FIG. 5, for full-pel motion estimation. Secondly, Ref_Data of pixels of the search area is being read, starting from the starting point (0, 0) of the search area, as shown in FIG. 6A, and fed into the motion estimation unit 1100, according to the pixel scan order as shown in FIG. 7. When Ref_Data corresponding to a pixel is read, the X and Y counters of the control unit 1600 count up as described above and the PE enabling logic circuit 1750 generates the enabling signals, denoted by PEZ_enable (Z=0 to 8), to the PE array unit 100. While Ref_Data of the search area is being read and fed into the motion estimation unit 1100, Curr_Data of the current macroblock is also read and fed into the motion estimation unit 1100 according to the pixel scan order for the current macroblock, for example, as previously described. Each PE of the 2D PE array unit 100 determines whether or not to process data fed into the PE in the current cycle according to the enabling signal PEZ_enable, and calculates the error measure correctly when the PE is enabled by PEZ_enable. When the search area is scanned completely and corresponding pixel data is fed into the 2D PE array unit completely, comparisons of the 9 reference macroblocks of the search area (corresponding to specified checking points) with a current macroblock are done in parallel, resulting in corresponding error measures, i.e. SADs in the embodiment, corresponding to the checking points, as shown in FIG. 6B. One of the checking points with the minimum error measure can then be determined according to the obtained error measures by the minimum SAD determination unit 1170. That is, one search step of N-step search algorithm for motion estimation can be performed by the 2D PE array unit 100 during a scanning of the search area. With the results of one step, the motion estimation system 1000 can be further configured to perform a successive step according to the N-step search algorithm until a best point, i.e. the minimum block distortion measure in the final step, is obtained, whereby a motion vector is determined. Therefore, any N-step search algorithm for motion estimation can be performed by the motion estimation system 1000 using the 2D PE array unit 100.

Specifically, during configuration of the 2D PE array unit 100, the HDUs and VDUs of the 2D PE array unit 100 are configured according to the step size of the current step of the step search algorithm. For example, when STEP_SIZE is set to 2 in the first step of the FSS algorithm for full-pel motion estimation, the HDUs, as shown in FIG. 3, are set by feeding a selection signal into the selection input terminal (MODE) so that the output of the FF 310 is selected by the multiplexer 350. Hence, every HDU has a delay time of 2 time units (cycles). Likewise, every VDU is set and has a delay time of 32 time units (cycles). When the 2D PE array unit 100 is to perform the final step of the FSS algorithm, every HDU is set to have a delay time of 1 time unit and every VDU is set to have a delay time of 16 time units. In one embodiment, step size may be changed from 4 to 2, or 2 to 1 in consecutive steps in order to perform the three-step search using the 2D PE array unit 100. In this case, the structure of the HDUs of the 2D PE array unit 100 can be modified, for example, based on the HDU 300 shown in FIG. 3, to have an extended delay time of 4 time units and to be set to have a delay time of 1, 2, or 4 time units, selectively. Similarly, the structure of the VDUs of the 2D PE array units 100 can be modified to have an extended delay time of 16×4 time units and can be set to have a delay time of 16, 32, or 64 time units, selectively.

During full-pel motion estimation, Ref_Data of the search area is being read, sequentially, line after line. In this embodiment, when PE0_Enable indicates “enabled”, or is asserted, a piece of current data, corresponding to a pixel of the current macroblock, is read before a piece of reference data, corresponding to a pixel of the search area, is read.

In one embodiment, efficient power reduction is achieved by using gated clock technique in the HDUs and VDUs of the 2D PE array unit 100 to control the shift registers. The memory read signal, Ref_ready, generated by the memory reading unit 1500 is applied in controlling the delay unit array of the 2D PE array unit 100. For example, in a full-pel motion estimation, the HDU enabling signals are set to a logic state corresponding to that of the memory read signal Ref_ready, and the VDU enabling signals is set a logic state equal to the result of the logic expression (Ref_ready & (X_count<16)), wherein Ref_ready is set to a high state when Ref_Data of a pixel of a search area is read from the reference memory. The HDU enabling signal is fed into the HEN terminal of the HDU, as shown in FIG. 3 while the VDU enabling signal is fed into the VEN terminal of the VDU, as shown in FIG. 4, wherein the clock signal CLK is fed into the CLK terminal.

Performance

In a MPEG-4 environment, for example, macroblock size is 16×16 pixels. It is assumed that a piece of reference data, corresponding to a pixel in the search area, Ref_Data, which is byte aligned, is read in one cycle, and 4 pieces of current data, corresponding to 4 consecutive pixels in the macroblock, Curr_Data, which are word aligned, is read in one cycle. In one embodiment, a modification of the motion estimation unit 1100 is illustrated in FIG. 9, wherein a register unit 1160 is used to store the 4 pieces of current data (32 bits), and a multiplexer 1150 is used to select one piece of current data (8 bits) from the register 1160 and to output the selected one to the 2D PE array unit 100. Step 1 of the FSS algorithm for the full-pel motion estimation requires reading (16+2×2)×(16+2×2)=400 pieces of reference data and reading 16×16=256 pieces of current data, wherein step size is 2. Because the reference data stored in the reference memory is byte aligned, not word-aligned, the reference data is read and accessed byte by byte. It is assumed under the best conditions, one piece of the reference data can be returned from the memory reading unit in one cycle. However, the current data stored in the current memory is word-aligned, and the current data is accessed and read word by word. In a 32-bits memory bus system, it is assumed under the best conditions, 4 pieces of the current data can be returned from the memory reading unit in one cycle. Thus, under the assumptions, step 1 of the full-pel motion estimation takes 400+64=464 cycles to complete. In the final step, (16+1×2)×(16+1×2)=324 pieces of reference data are required to read. That is, the final step of the full-pel motion estimation is completed in 324+64=384 cycles. Therefore, in the worst case, a four step search with respect to one current macroblock takes about 464×3+324=1716 cycles to complete. Further, early termination is one of characteristics of the four step search algorithm so that a motion vector, on average, can be determined in about 2.5 steps, with an average computation time of about 1716×2.5/4=1072.5 cycles.

Advantages The 2D PE array unit in the above embodiments is constructed with 9 PEs working in parallel, being supplied with data flows in simple orders, and being controlled correspondingly.

Since the pixel scan order, as shown in FIG. 7, is simply sequential and consecutive, the hardware implementation in controlling the 2D PE array unit and address generation is regular and simple. Thus, a reduced circuit area for the motion estimation system is achieved.

The reference data and current data that are fed into the 2D PE array unit are suitably reused during the computation of a motion estimation. The computation speed of the 2D PE array unit is 9 times faster than that of a conventional one with only one PE.

In addition, the number of times of memory access of the 2D PE array unit is 9 times less than that of a conventional one with only one PE. Since power dissipation is proportional to the number of times of memory access and a reduced number of times of memory access is achieved, the 2D PE array unit efficiently saves power. The motion estimation system using the 2D PE array unit is therefore suitable for a mobile processing device, such mobile phone or PDA, which is with a limited power supply.

Further, in the motion estimation system according to the invention, a reduced number of access times to the memory bus is achieved, the utilization of the memory bus is increased.

Memory resource is also saved because additional large memory blocks, as used in some conventional approaches, for buffering reference data and current data are not needed. According to the embodiments of the invention, the computation of a motion estimation is performed while the reference data is being fed into the 2D PE array unit.

Furthermore, the 2D PE array unit is a flexible architecture that can be adaptable to different motion estimation algorithms and can be extendable its utilization. In particular, as disclosed in the above embodiments of the invention, the 2D PE array unit is configured to perform N-step search algorithm for motion estimation. The 2D PE array unit can be utilized in a motion estimation system supporting a specific type of algorithm. In addition to the FSS algorithm, any N-step search algorithm, such as three step search or 3-3-3-1 search algorithms for motion estimation can therefore be performed using the 2D PE array unit, where the first to fourth steps of the 3-3-3-1 search algorithm have step sizes of 3, 3, 3, and 1, respectively. A motion estimation system with the 2D PE array unit can also support a variety of algorithms, e.g. FSS and TSS algorithms, selectively.

Although originally configured for full-pel motion estimation, the 2D PE array unit shown in FIG. 5 can also perform sub-pixel motion estimations, such as half-pel or quarter-pel motion estimation, provided that sub-pixel data is all prepared before fed into the 2D PE array unit. However, this approach additionally requires a conversion process for converting integral-pixel data into sub-pixel data, and requires a memory block for temporarily store all of the sub-pixel data resulted from the conversion process. Besides, the 2D PE array unit begins half-pel motion estimation only if the conversion process has finished, and the number of times of memory reading and writing operations to this additional buffer during the conversion process will increase the total computation time.

In the following, a configuration of the 2D PE array unit in FIG. 1 will be configured to perform half-pel motion estimation without the need of a memory block to store all of the sub-pixel data, and to obtain an optimal benefit from the parallelism and pipelining that are inherent in the configuration of the 2D PE array unit in FIG. 1 according to the invention.

In order to obtain an optimal benefit from the parallelism and pipelining that are inherent in the configuration of the 2D PE array unit in FIG. 1, a half-pel values generation unit is provided and the 2D PE array unit is configured to perform half-pel motion estimation with the half-pel values generation unit.

Configuration of the 2D PE Array Unit for Performing Half-Pel Motion Estimation

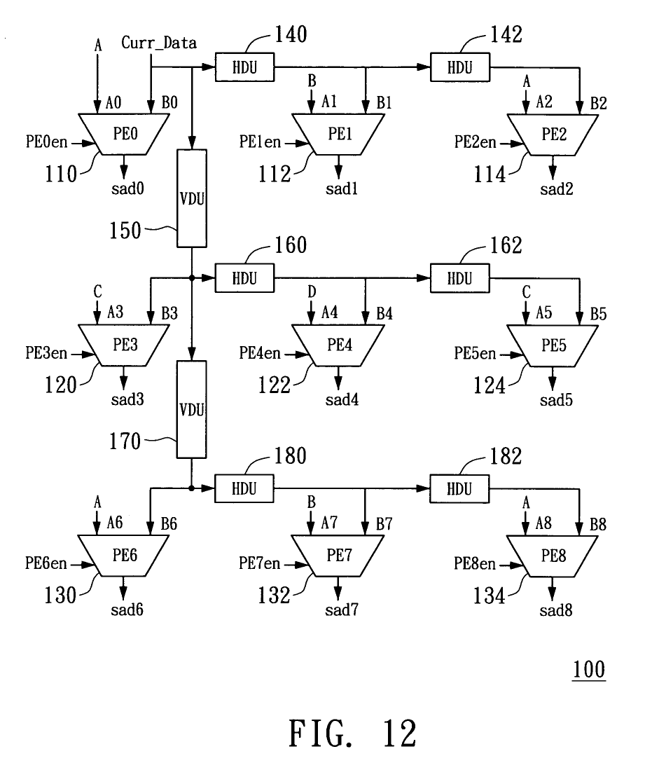

Referring to FIG. 12, a configuration of the 2D PE array unit of FIG. 1 is illustrated to perform half-pel motion estimation according to a fourth embodiment of the invention. When a best point found by a full-pel motion estimation is obtained at a first stage, the full-pel best point can be refined with half-pel accuracy at a second stage by a half-pel motion estimation with respect to the full-pel best point. According to the fourth embodiment of the invention, a current macroblock having a starting point at the full-pel best point, regarded as C(0, 0), is compared with 9 reference macroblocks associated with the full-pel best point and 8 neighboring half-pel checking points in parallel while the pixel data corresponding to full-pels in a search area is being scanned. The search area, R(i, j) where i=−1 to 16 and j=−1 to 16, on a previous frame is two pixels larger than the current macroblock in terms of width and length, and the current macroblock is defined as C(x, y), x=0 to 15 and y=0 to 15. When the pixel data of the full-pels, or called full-pel values, denoted by DR(i, j), of the search area is being read sequentially, line after line, from the point R(−1, −1) to R(16, 16), a number of groups of four half-pel values generated in parallel are fed into the 2D PE array unit in FIG. 12, group after group. While groups of four half-pel values are fed into the 2D PE array unit in FIG. 12, the PEs compute their corresponding error measures in parallel. When the scanning of the search area is completed, 9 error measures are determined and a motion vector with half-pel accuracy can then be obtained.

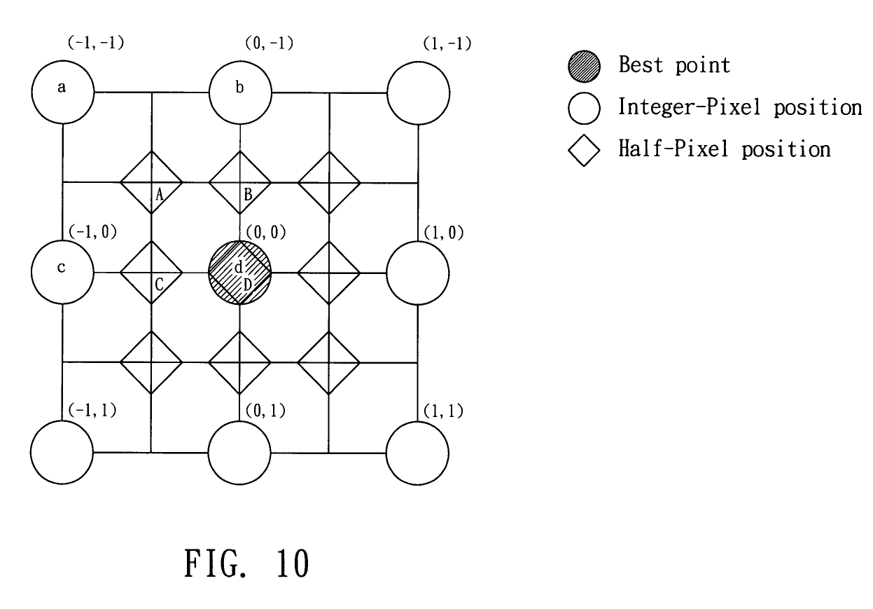

In FIG. 12, input data A is fed into the first input terminals of PE0, PE2, PE6, PE8; input data B is fed into the first input terminals of PE1, PE7; input data C is fed into the first input terminals of PE3, PE5; input data D is entered into the first input terminal of PE4, where A, B, C, and D represent pixel values that correspond to half-pels indicated by diamonds with letters A, B, C, and D in FIG. 10, respectively. As observed from FIG. 10, pixel data A, B, C, D of half-pixels R(−0.5, −0.5), R(0, −0.5), R(−0.5, 0), R(0, 0), can be derived from pixel data a, b, c, d of integer-pixels R(−1, −1), R(0, −1), R(−1, 0), R(0, 0).

Half-Pel Values Generation

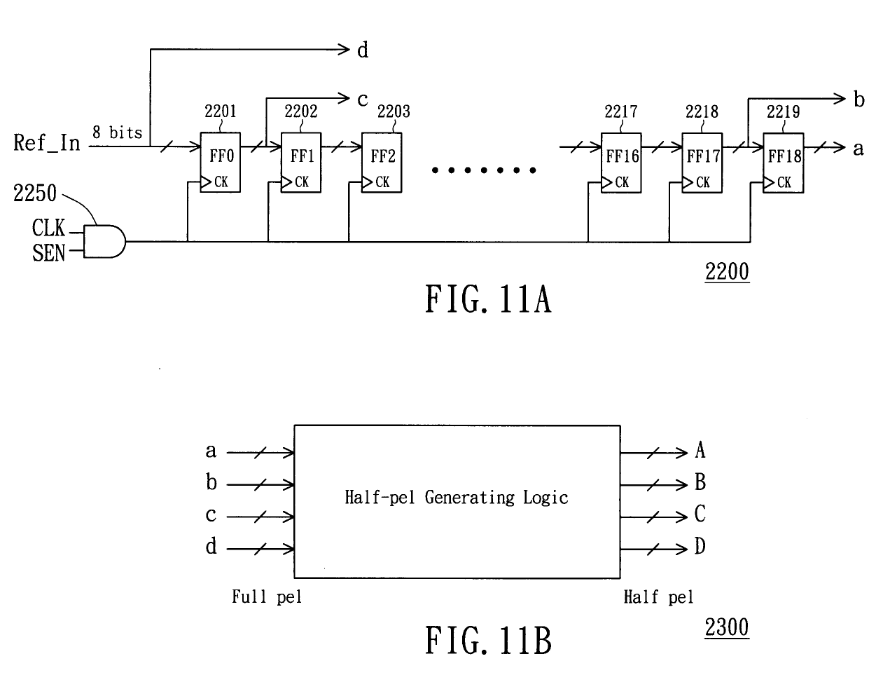

In order to provide a group of four half-pel values at one time when a full-pel value is read, a half-pel values generation unit including two additional circuits is employed with the 2D PE array unit configured in FIG. 12 in the fourth embodiment. The half-pel values generation unit includes a preparation delay unit and a half-pel generating circuit. Referring to FIG. 11A, a preparation delay unit 2200 is illustrated to provide four full-pel values a, b, c, d in parallel after a specific time (cycles) is elapsed. In FIG. 11A, 19 flip-flops (FFs), FF 2201 to FF 2219, are serially connected and controlled by a control signal outputted by an AND logic gate 2250, wherein a full-pel value from the search area is applied to an input Ref_In. After a time period for preparation, called a prefetch cycle, the 19 FFs are fed with data, the four full-pel values, a, b, c, d can be outputted synchronously. Referring to FIG. 11B, a half-pel generating circuit 2300 is provided to convert the pixel data a, b, c, d into the pixel data A, B, C, D, correspondingly, by the following logical expressions:
A=(a+b+c+d+2-rounding)>>2,
B=(b+d+1-rounding)>>1,
C=(c+d+1-rounding)>>1,
D=d,
where A, B, C, D are half-pel values, and a, b, c, d are full-pel values.
Search Area and Checking Points

In the half-pel motion estimation, the search area is defined differently from that in full-pel motion estimation: search area=x_range·y_range, wherein x_range=16+STEP_SIZE×2=18, and y_range=16+STEP_SIZE×2=18, STEP_SIZE is 1. Particularly, checking points in the half-pel search are defined around a best point, regarded as R(0, 0), found in a full-pel search. Referring to FIG. 10, all circles are full-pels and the circle with encircled inclined lines at the center represents the full-pel best point, while the 9 diamonds indicate 9 checking points. A half-pel accurate motion vector is found by finding a best match out of R(0, 0), and its eight neighbors: R(−0.5, −0.5), R(0, −0.5), R(0.5, −0.5), R(−0.5, 0), R(0.5, 0), R(−0.5, 0.5), R(0, 0.5), R(0.5, 0.5). The 9 checking points are associated with 9 macroblocks having starting points at R(−0.5, −0.5), R(0, −0.5), R(0.5, −0.5), R(−0.5, 0), R(0, 0), R(0.5, 0), R(−0.5, 0.5), R(0, 0.5), R(0.5, 0.5), respectively. With the step size of 1 between two adjacent points in horizontal and vertical directions, each of the macroblocks consists of 16×16 half-pels that can be obtained based on the full-pels around them by interpolation. The full-pel values, denoted by DR(i, j), of the search area, are used to generate half-pel values DR(i+0.5, j+0.5) of the search area, where i=−1 to 16 and i=−1 to 16. It is noted that step size in the half-pel motion estimation is 1.

Half-Pel Motion Estimation Operation

The operation of the half-pel motion estimation is described as follows.

First, a 2D PE array unit is configured as shown in FIG. 12 to perform half-pel motion estimation, wherein the VDUs and HDUs are set to have specific delay times.

Secondly, a pre-fetching cycle begins for generating the first group of four half-pel values. In the pre-fetching cycle, full-pel values, Ref_Data, corresponding to the pixels of the search area, DR(−1, −1) to DR(16,16), are sequentially read and fed into the half-pel values generation unit. In this embodiment, a full-pel value of the search area is fed into the input terminal Ref_In of the preparation delay unit 2200. When the 20-th full-pel value DR(0, 0) from the search area is applied to the delay unit 2200, the full-pel values a, b, c, d can be outputted at the same time and then be applied to the half-pel generating circuit 2300. Four half-pel values A, B, C, D are generated by the half-pel generating circuit 2300 at the same time and are fed into the 2D PE array unit in FIG. 12.

Thirdly, the 2D PE array unit in FIG. 12 computes error measures accumulatively while groups of half-pel values A, B, C, D are fed into the 2D PE array unit in FIG. 12, group after group. The 2D PE array unit in FIG. 12 begins performing error measures with respect to the corresponding checking points R(−1, −1), R(0, −1), R(−1, 0), R(0, 0) when the first group of half-pel values are fed into. When the full-pel values DR(i, j) of the search area are read sequentially, line after line, error measures with respect to the nine checking points R(−0.5, −0.5), R(0, −0.5), R(0.5, −0.5), R(−0.5, 0), R(0, 0), R(0.5, 0), R(−0.5, 0.5), R(0, 0.5), R(0.5, 0.5) are performed accumulatively. Enabling signals are applied to the 2D PE array unit in FIG. 12 to enable the corresponding PEs to process data fed into the PEs. When the scanning of the search area is completed, the nine error measures are determined. One of the nine checking points with the minimum error measure is then determined to obtain the motion vector with half-pel accuracy.

In order to fulfil the requirements of the operation, pixel scan order, delay units, and the control of the PE array are required to be specified with respect to the half-pel motion estimation to be performed by the 2D PE array unit in FIG. 12.

Pixel Scan Order for Half-Pel Motion Estimation

The pixel scan order for the search area in half-pel motion estimation is similar to that in full-pel motion estimation as illustrated in FIG. 7 according to the fourth embodiment of the invention. The reference data of the search area is being read sequentially, line after line, from the starting point, denoted by R(−1, −1), to the ending point of the search area, denoted by R(−1+x_range−1, −1+y_range−1)=R(16, 16), where x_range=18 and y_range=18.

Likewise, pixel values of the current macroblock are read sequentially, line after line, from the starting point C(0, 0) to the ending point C(15, 15). However, it should be noted that a prefetch cycle, as above described, is to be elapsed before the scanning of the current macroblock begins, wherein the first group of four half-pel values, i.e. A, B, C, D as indicated in FIG. 10, are provided after the prefetch cycle. During the prefetch cycle, full-pel values from DR(−1, −1) to DR(−1, 0), total 19 full-pel values, are fed into the preparation delay unit 2200, sequentially, line after line, from left to right. When PE0 (or PE1) is enabled, i.e. when the enabling signal PE0_Enable applied to the control terminal PE0en of PE0 indicates “enabled”, the pixel values of the current macroblock, DC(0, 0) to (15, 15), are read in the above pixel scan order for the current macroblock. In one embodiment, when PE0 (or PE1) is enabled, a piece of current data is read immediately before a piece of reference data is read.

In FIG. 12, the PEs determine the error measures, e.g. SADs in this embodiment, corresponding to the checking points shown in FIG. 10 in half-pel motion estimation. For example, PE0 is used for comparing the current macroblock to a reference macroblock associated with checking point R(−0.5, −0.5) using SAD, wherein the checking point is the upper left half-pel represented by a diamond indicated by A in FIG. 10. In addition, PE1 to PE8 are used for comparing the current macroblock to the reference macroblocks associated with checking points R(0, −0.5), R(0.5, −0.5), R(−0.5, 0), R(0, 0), R(0.5, 0), R(−0.5, 0.5), R(0, 0.5), R(0.5, 0.5) using SAD, respectively.

In order for each of the PEs in FIG. 12 to correctly determine an error measure, i.e. SAD, associated with the corresponding checking point, half-pel values A, B, C, D from the half-pel generating circuit 2300 and the current data are required to be correctly, for example, synchronously applied to the PE array. For instance, PE0 computes an absolute difference correctly when the half-pel value DR(−0.5, −0.5), i.e. A indicated in FIG. 10, and the full-pel value, denoted by DC(0, 0), i.e. d in FIG. 10, both are synchronously applied to the first input terminal A0 and second input terminal B0, respectively. Similarly, PE1, PE3, and PE4, determine respective absolute differences correctly when the half-pel values DR(0, −0.5), DR(−5, 0), and DR(0, 0), i.e. B, C, and D in FIG. 10, are respectively fed into the first input terminals of PE1, PE3, and PE4, synchronously with the full-pel value DC(0, 0) applied to the second input terminals of PE1, PE3, and PE4. Thus, half-pel values A, B, C, D provided at a time are fed into PE0, PE1, PE3, and PE4, for example, synchronously with full-pel value DC(i, j), so that the PE0, PE1, PE3, and PE4 determine respective error measures correspondingly.

With respect to PE0, after the full-pel value of the last pixel in a row of the current macroblock is read and applied to the second input terminal B0, PE0 is disabled. In this time, the scanning of the search area continues. In addition, the scanning of the current macroblock pauses until the first pixel of the next row of the search area is scanned. When the first pixel of the next row of the search area is to be scanned, PE0 is enabled again and the scanning of the current macroblock continues. In this way, the half-pel value of the next row of the current macroblock and the half-pel values of the next row of the search area can be correctly, e.g. synchronously, applied to PE0. The scanning of the current macroblock is done in the above manner so that the other PEs can receive correct pixel values for determining error measures, correspondingly. The other PEs have pixel values inputted correctly by the help of the delay unit array.

Delay Units for Half-Pel Motion Estimation

With the pixel scan orders for the search and the current macroblock, delay units are required to have respect delay times in order to reuse current data, i.e. full-pel values from the current macroblock. As above discussed, half-pel values A, B, C, D provided at a time are fed into PE0, PE1, PE3, and PE4, for example, synchronously with full-pel value DC(i, j), so that the PE0, PE1, PE3, and PE4 determine respective error measures correspondingly. Therefore, the HDUs 140, 160, and VDU 150 are set to have no delay time in this embodiment. With regard to the other PEs, settings are done in view of data reuse of the current data as follows.

Referring to FIGS. 10 and 12, when PE0 is enabled, the full-pel value DC(0, 0) is read and fed into the array unit. The full-pel value DR(0, 0) is read immediately after the full-pel value DC(0, 0) in this example, and a first group of four half-pel values, i.e. A, B, C, and D, are generated and fed into PE0, PE1, PE3, and PE4 respectively. The other PEs, i.e. PE2, PE5, PE6, PE7, and PE8, are disabled because the first group of four half-pel values are not included in the macroblocks associated with the corresponding checking points of the PEs. However, the full-pel value DC(0, 0) is required to be reused when PE2, PE5, PE6, PE7, and PE8 are enabled. Referring to FIG. 10, the next group of four half-pel values including DR(0.5, −0,5) and DR(0.5, 0) are generated in the next cycle when the full-pel value DC(1, 0) is read. Referring to FIG. 12, when the half-pel values DR(0.5, −0,5) and DR(0.5, 0) are generated, PE2 and PE5 are enabled and the two half-pel values are fed into the first input terminals A2 and A5 while the full-pel value DC(0, 0) that is read in the previous cycle is outputted from the HDUs 142 and 162 to the second input terminals B2 and B5. Thus, each of the HDU 142 and 162 has a delay time of one time unit (cycle), with the assumption that a full-pel value of the current macroblock is read at every cycle when PE0 is enabled.

Referring to FIG. 10, a group of four half-pel values including DR(−0.5, 0,5) and DR(0.5, 0) are generated in a subsequent cycle when the full-pel value DC(0, 1) is read. Referring to FIG. 12, when the half-pel values DR(−0.5, 0,5) and DR(0.5, 0) are generated, PE6 and PE7 are enabled and the two half-pel values are fed into the first input terminals A6 and A7 while the full-pel value DC(0, 0) that is read in the previous cycle is outputted from the VDU 170 and HDU 180 to the second input terminals B6 and B7, respectively. Thus, the VDU 170 is set to have a delay time of 16 time units and the HDU 180 is set to have a delay time of 0. In this way, when the full-pel value DC(0, 1) is read, the next group of four half-pel values including DR(0.5, 0,5) are generated in the next cycle. Referring to FIG. 12, when the half-pel values DR(0.5, 0,5) is generated, PE8 is enabled and the half-pel value is fed into the first input terminal A 8 while the full-pel value DC(0, 0) that is read in the previous cycle is outputted from the HDU 180 to the second input terminals B8. Thus, the HDU 180 is set to have a delay time of one time unit.

Control of the PE Array for Half-Pel Motion Estimation

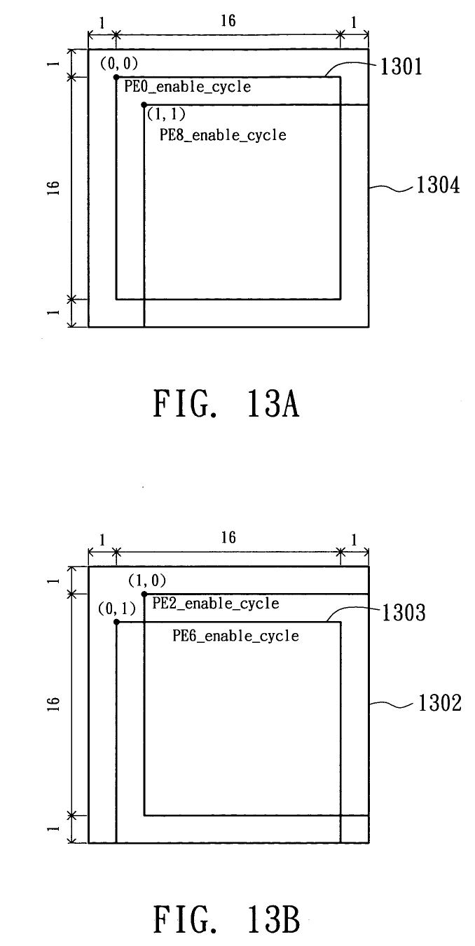

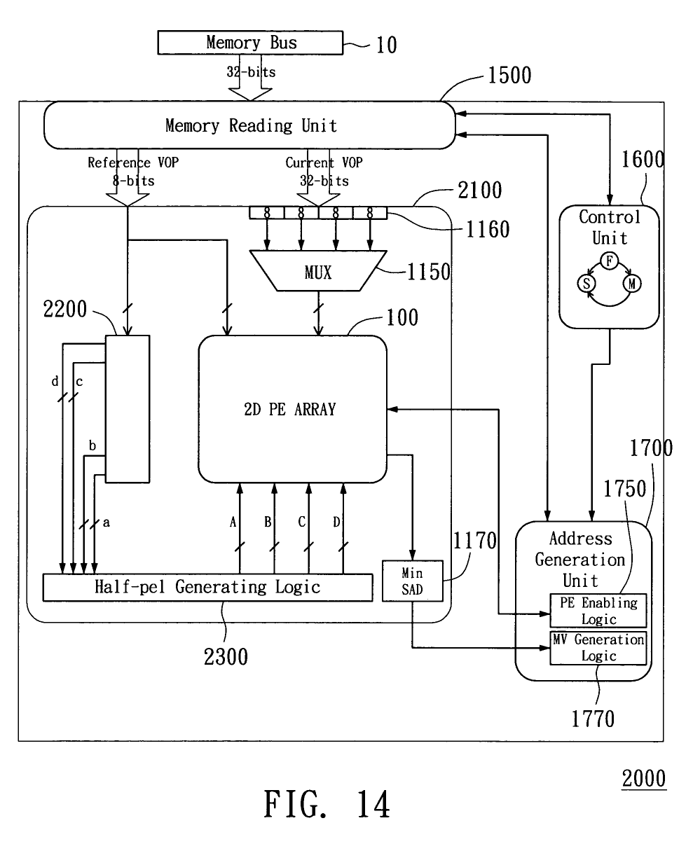

Consistent with the above discussions, the 9 PEs as shown in FIG. 12 have four PE enabling cycles according to the fourth embodiment of the invention to make the PE array unit operate properly. In particular, these enabling cycles overlap one another, indicating that some of the 9 PEs function in parallel at some time during the scanning of the reference data. The enabling cycles, denoted by PE0_enable_cycle, of PE0, PE1, PE3, and PE4 are identical. The enabling cycles, denoted by PE2_enable-cycle, of PE2 and PE5 are the same. PE6 and PE7 also have the identical enabling cycles, denoted by PE6_enable_cycle. PE8 has its own enabling cycle, denoted by PE8_enable_cycle. These PE enabling cycles can be defined intuitively by subdividing the search area into a subset of sub-areas of the same size as that of the current macroblock. Referring to FIGS. 13A and 13B, four sub-areas 1301-1304 associated with starting points R(0, 0), R(1, 0), R(0, 1), and R(1, 1) are to define the four enabling cycles associated with PE0, PE2, PE6, and PE8, respectively.

With the definition of enabling cycles, the control of the PE array is convenient and the implementation is less complexity. For example, a PE enabling logic circuit can be implemented to determine which one of the sub-areas includes a pixel R(i, j) when a full-pel value DR(i, j) is read. For each sub-area that is determined to include the pixel R(i, j), a corresponding one of the enabling signals is enabled and applied to the corresponding control terminal of the PE associated with the sub-area (or enabling cycle), whereby the PE array is controlled.

For instance, when DR(1, 0) is read, the PE enabling logic circuit determines that PE0_enable_cycle and PE2_enable_cycle, (two sub-areas) include pixel R(1, 0). For the two sub-areas that are determined to include pixel R(1, 0), enabling signals, i.e. PE0_Enable, PE1_Enable, PE3_Enable, PE4_Enable, and PE2_Enable, PE5_Enable, are enabled and applied to the corresponding control terminals, i.e. PE0en, PE1en, PE3en, PE4en, and PE2en, PE5enof the PEs associated with the enabling cycles PE0_enable_cycle and PE2_enable_cycle.

Consistent with the fourth embodiment for performing half-pel motion estimation, TABLE 2 lists enabling conditions for the 9 PEs in FIG. 12 specifically, wherein the starting point of the search area is defined as (−1, −1). TABLE 2 specifies the conditions in which the enabling signals, denoted by PEZ_Enable (Z=0 to 8), are enabled when a pixel value DR(X, Y) corresponding to a full-pixel R(X, Y) of the search area is included in the sub-areas. In addition, the enabling signals, PEZ_Enable (Z=0 to 8), in the second embodiment, are fed into the control terminals PEZen (Z=0 to 8), of PE0 to PE8, respectively.

TABLE 2

| | Enabling conditions | |
|---|---|---|
| | Half-Pel | Enabling cycles |
| PE0_Enable | X = 0˜15, Y = 0˜15 | PE0_enable_cycle |
| PE1_Enable | X = 0˜15, Y = 0˜15 | PE0_enable_cycle |
| PE2_Enable | X = 1˜16, Y = 0˜15 | PE2_enable_cycle |
| PE3_Enable | X = 0˜15, Y = 0˜15 | PE0_enable_cycle |
| PE4_Enable | X = 0˜15, Y = 0˜15 | PE0_enable_cycle |
| PE5_Enable | X = 1˜16, Y = 0˜15 | PE2_enable_cycle |
| PE6_Enable | X = 0˜15, Y = 1˜16 | PE6_enable_cycle |
| PE7_Enable | X = 0˜15, Y = 1˜16 | PE6_enable_cycle |
| PE8_Enable | X = 1˜16, Y = 1˜16 | PE8_enable_cycle |

Note:
The starting point of the search area defined as (−1, −1)

Architecture of a Motion Estimation System for Full-Pel and Half-Pel Motion Estimation

Referring to FIG. 14, a motion estimation system 2000 is provided according a fifth embodiment of the invention. The motion estimation system 2000 includes a motion estimation unit 2100, a memory reading unit 1500, a control unit 1600, and an address generation unit 1700. FIG. 14 illustrates a system that can perform a full-pel motion estimation using a step-search algorithm, for example the FSS algorithm, at a first stage, and the system can then, selectively, perform a half-pel motion estimation with respect to a best point found in the full-pel motion estimation to obtain a motion vector with half-pel accuracy at a second stage. The motion estimation system 2000 can be further configured to perform arbitrary N-step search algorithm for full-pel motion estimation, for example, the three step search algorithm, as the system 1000 shown in FIG. 9 with the corresponding description. However, it is noted that the motion estimation system 2000 can selectively perform a half-pel motion estimation so as to refine a motion vector obtained from a full-pel motion estimation with half-pel accuracy. For the sake of brevity, the conditions or operations for the full-pel motion estimation at the first stage will not be repeated in the following description. In regard to performing full-pel motion estimation with the motion estimation system 2000, it is recommended to refer to the description and figures corresponding to full-pel motion estimation.

The motion estimation unit 2100 includes a 2D PE array unit 100, a multiplexer 1150, a register unit 1160, and a minimum SAD determination unit 1170. In addition, the motion estimation unit 2100 includes a half-pel values generation unit for outputting a group of half-pel values, in parallel to the 2D PE array unit 100. h includes a preparation delay unit 2200 and a half-pel generating circuit 2300. Examples of the preparation delay unit 2200 and half-pel generating circuit 2300 are shown in FIGS. 11A and 11B.

The memory reading unit 1500 is a memory reading interface for the motion estimation system 2000, wherein the memory reading interface can be implemented to be compliant with at least one communication protocol that is employed by a memory bus 10 coupled to the motion estimation system 2000.

The control unit 1600 is used to count for a step search. The control unit 1600 can be a finite state machine, for example, including two counter circuits, X counter and Y counter, to count for a step search. The X counter counts how many pixels whose pixel value is read in a row of a search area. The Y counter counts how many pixel columns whose pixel values are read in the search area. The X counter increases by one when a piece of Ref_Data, corresponding to a pixel in the search area, is read. The Y counter increases by one when X counter reaches a predetermined value, denoted by X_max_count, and then X counter is reset to 0. When Y counter reaches y_range, the step of the step search algorithm is ended. Because the motion estimation system 2000 can operate in two different stages for full-pel motion estimation and half-pel motion estimation selectively. The X and Y counters are required to reach different predetermined values for full-pel motion estimation and half-pel motion estimation.

At the first stage for full-pel motion estimation, X_max_count is the width of the search area (number of pixels), i.e. X_max_count=x_range. In step 1 to step n-1 of full-pel motion estimation, X_max_count=x_range=macroblock_size+STEP_SIZE×2. For example, in FSS algorithm, X_max_count=16+2×2=20, where STEP_SIZE=2 except for the final step. For the final step of full-pel motion estimation or half-pel motion estimation, X_max_count=x_range but the SIZE_SIZE may be changed to a reduced value. In half-pel motion estimation, X_max_count=16+1×2=18, where STEP_SIZE is 1. The memory reading unit 1500 generates a memory read signal, denoted by Ref_ready, to the control unit 1600. The memory read signal is used to inform the X and Y counters to update their count values. For example, Ref_ready is set to be enabled, e.g. a high level, when a piece of Ref_Data, corresponding a pixel of the search area, is read from a memory, e.g. the reference memory. The PE enabling cycles are determined according to the current count values X and Y from the X and Y counters, and the enabling conditions, as specified in TABLE 1 for full-pel motion estimation and TABLE 2 for half-pel motion estimation.

The address generation unit 1700 includes a PE enabling logic circuit 1750 and a motion vector (MV) generation logic circuit 1770. The PE enabling logic circuit 1750 receives the current count values X and Y from the X and Y counters of the counter unit 1600; generates enabling signals according to the current count values X, Y and either TABLE 1 for full-pel motion estimation or TABLE 2 for half-pel motion estimation; and outputs the enabling signals to the 2D PE array unit 100 of the motion estimation unit 2100. As above described, after the scanning of the search area, 9 error measures, e.g. 9 SADs corresponding to the nine checking points in the second embodiment, are obtained, and a minimum error measure is determined and outputted by the minimum SAD determination unit 1170. The address generation unit 1700 receives the minimum error measure outputted by the minimum SAD determination unit 1170. At the first stage, the MV generation logic circuit 1770 generates a motion vector in the final step of the search algorithm. If a half-pel motion estimation is to be performed at the second stage, the motion vector obtained in the first stage will be used as a basis to determine its refinement with half-pel accuracy. In addition, the address generates unit 1700 generates memory addresses to the memory reading unit 1500 so that reference data and current data are read from the memory reading unit 1500 and fed into the motion estimation unit 1100.

Operation of the Motion Estimation System During Half-Pel Motion Estimation

The operation of the motion estimation system 2000 is illustrated to perform a half-pel motion estimation. Suppose that the motion estimation system 2000 obtains a best point found in a full-pel motion estimation at the first stage and operates with a clock signal, CLK. First, the 2D PE array unit 100 is configured, as shown in FIG. 12, for half-pel motion estimation. Secondly, a prefetch cycle begins in which full-pel values, Ref_Data, of the search area is being read, starting from the starting point R(−1, −1) to R(−1, 0) of the search area and fed into the preparation delay unit 2200 of the motion estimation unit 2100 in order for the half-pel generating circuit 2330 to output group of four half-pel values to the 2D PE array unit 100. Thirdly, PE0_enable is enabled and DR(0, 0) is read, the X and Y counters of the control unit 1600 count up as described above and the PE enabling logic circuit 1750 generates the enabling signals, denoted by PEZ_enable (Z=0 to 8), to the PE array unit 100 according to TABLE 2. While full-pel values of the search area are being read and fed into the motion estimation unit 2100 in the pixel scan order for the search area, full-pel values, Curr_Data, of the current macroblock are also read and fed into the motion estimation unit 2100 in the pixel scan order for the current macroblock, for example, as described in the section “PIXEL SCAN ORDER FOR HALF-PEL MOTION ESTIMATION”. Each PE of the 2D PE array unit 100 determines whether or not to process data fed into the PE in the current cycle according to the enabling signal PEZ_enable, and calculates the error measure correctly when the PE is enabled by PEZ_enable. When the search area is scanned completely and corresponding pixel data is fed into the 2D PE array unit completely, comparisons of the 9 reference macroblocks of the search area (corresponding to specified checking points) with a current macroblock are done in parallel, resulting in corresponding error measures, i.e. SADs in the embodiment, corresponding to the half-pel checking points, as shown in FIG. 10. That is, the half-pel motion estimation can be performed by the 2D PE array unit 100 during a scanning of the search area. One of the half-pel checking points with the minimum error measure can then be determined according to the obtained error measures by the minimum SAD determination unit 1170, whereby a motion vector with half-pel accuracy is determined. Therefore, any N-step search algorithm for motion estimation can be performed by the motion estimation system 1000 using the 2D PE array unit 100.

Specifically, during configuration of the 2D PE array unit 100, the HDUs and VDUs of the 2D PE array unit 100 are configured, for example, as described in the section “DELAY UNITS FOR HALF-PEL MOTION ESTIMATION”.

During full-pel motion estimation, Ref_Data of the search area is being read, sequentially, line after line. In this embodiment, when PE0_Enable indicates “enabled”, or is asserted, a piece of current data, corresponding to a pixel of the current macroblock, is read before a piece of reference data, corresponding to a pixel of the search area, is read.

In one embodiment, efficient power reduction is achieved by using gated clock technique in the HDUs and VDUs of the 2D PE array unit 100 to control the shift registers. In half-pel motion estimation, the memory read signal, Ref_ready, generated by the memory reading unit 1500 is applied in controlling the delay unit array of the 2D PE array unit 100 and the preparation delay unit 2200. For example, in a half-pel motion estimation, the HDU enabling signals, HEN_CS, are set to a logic state equal to a logic expression: HEN_CS=Ref_ready & (X_count>0) & (Y_count>0) for matching the timing of PE1_Enable. The VDU enabling signals, VEN_CS, are set a logic state equal to a logic expression: VEN_CS=HEN_CS & (X_count<17). The enabling signal for the preparation delay unit 2200, SEN_CS is set by: SEN_CS=Ref_ready. It is noted that Ref_ready is set to a high state when Ref_Data of a pixel of a search area is read from the reference memory. The HDU enabling signal is fed into the HEN terminal of the HDU, as shown in FIG. 3 while the VDU enabling signal is fed into the VEN terminal of the VDU, as shown in FIG. 4. The enabling signal for the preparation delay unit 2200, SEN_CS, is fed into the SEN terminal thereof, as shown in FIG. 11A. All of the delay units are fed with the clock signal CLK at the CLK terminal.

Performance for Half-Pel Motion Estimation

The assumptions as described in the section “PERFORMANCE” for full-pel motion estimation are taken. A half-pel motion estimation requires reading (16+1×2)×(16+1×2)=324 pieces of reference data and reading 16×16=256 pieces of current data in the above embodiment. Thus, under the assumptions, the half-pel motion estimation with respect to a current macroblock takes 324+256/4=388 cycles to complete.

Advantages

In the fourth and fifth embodiments of the invention, the configuration of the 2D PE array unit for performing half-pel motion estimation and an architecture of a motion estimation system for full-pel and half-pel motion estimation are disclosed. According to the embodiments, a half-pel values generation unit with a preparation delay unit and a half-pel generating circuit is disclosed to operate with the 2D PE array unit configured to perform half-pel motion estimation. The 2D PE array unit as shown in FIG. 1 can be selectively configured to perform full-pel and half-pel motion estimation.

An optimal benefit from the parallelism and pipelining that are inherent in the 2D PE array unit in FIG. 1 according to the invention is achieved. During the scanning of a search area, either for half-pel or full-pel search, the 2D PE array unit can compare a current macroblock with a set of reference macroblocks in the search area in parallel. When the scanning of the search area is completed, a step search of half-pel search is completed.

The pixel scan orders for the search area and macroblock are regular and simple so that the control logic and enabling signals can be implemented without using complicated hardware. The 2D PE array unit is expandable and flexible in circuit design. In addition to half-pel motion estimation, the 2D PE array unit can be further adapted for any sub-pixel motion estimation, e.g. quarter-pel motion estimation, 1/8 -pel motion estimation and so on.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for motion estimation, comprising:
a processing element (PE) array unit comprising:
a delay unit array comprising:
a plurality of horizontal delay units (HDUs) having 3 rows of HDUs, each row having a first HDU and a second HDU, each HDU including an input terminal and an output terminal, wherein in each row, the output terminal of the first HDU is connected to the input terminal of the second HDU; and
a plurality of vertical delay units (VDUs) having a first VDU and a second VDU, each having an input terminal and an output terminal, wherein the input terminal of the first VDU is connected to the input terminal of the first HDU of the first row, the output terminal of the first VDU is connected to the input terminal of the first hdu of the second row and the input terminal of the second VDU, the output terminal of the second VDU is connected to the input terminal of the first HDU of the third row;
and
a processing element (PE) array having 3 rows of processing elements (PEs), each row having first, second, and third PEs, each PE including a first input terminal and a second input terminal, an error measure output terminal, and a control terminal, wherein in each row, the second input terminal of the first PE is connected to the input terminal of the first HDU, the second input terminal of the second PE is connected to the output terminal of the first HDU, the second input terminal of the third PE is connected to the output terminal of the second HDU, wherein each PE calculates an error measure accumulatively between reference data at the first input terminal and pixel data at the second input terminal when the control terminal is enabled.

2. The apparatus for motion estimation according to claim 1, wherein a macroblock of P by Q pixels with a starting point defined as C(0, 0) and a search area of L by J pixels with a starting point defined as R(0, 0) are defined, where L=2×STEP-SIZE+P, J=2×STEP_SIZE+Q; wherein the apparatus further comprises:
a memory reading unit for reading reference data, denoted by DR(i, j), corresponding to a pixel R(i, j) of the search area, sequentially, line after line, from the starting point R(0, 0) to R(L−1, J−1) and outputting pixel data, denoted by DC(p, q), corresponding to a pixel C(p, q) of the macroblock, sequentially, line after line, from the starting point C(0, 0) to C(P−1, Q−1);
wherein the pixel data DC(p, q) read by the memory reading unit is applied to the input terminal of the HDU of the first row, and the reference data DR(i, j) read by the memory reading unit is applied to the first input terminal of each PE of the PE array.

3. The apparatus for motion estimation according to claim 2, wherein:
the search area is divided into a subset of sub-areas of P by Q pixels, associated with an array of checking points (0, 0), (STEP_SIZE, 0), (2×STEP_SIZE, 0), (0, STEP_SIZE), (STEP_SIZE, STEP_SIZE), (2×STEP_SIZE, STEP_SIZE), (0, 2×STEP_SIZE), (STEP_SIZE, 2×STEP_SIZE), and (2×STEP_SIZE, 2×STEP_SIZE) respectively, each sub-area in the subset of sub-areas having a starting point defined as the respective checking point;
each of the HDUs has a delay time of STEP_SIZE time units;
each of the VDUs has a delay time of STEP_SIZE×P time units; and
the PE array is for accumulatively calculating the error measures with respect to the array of checking points respectively;
wherein the apparatus further comprises:
a processing element (PE) enabling circuit for generating a plurality of enabling signals for controlling the PE array to calculate the corresponding error measures,
wherein when the memory reading unit reads the reference data DR(i, j), the PE enabling circuit determines which one of the subset of sub-areas includes pixel R(i, j); for each sub-area that is determined to include the pixel R(i, j), a corresponding one of the enabling signals is enabled and applied to the corresponding control terminal of the PE that corresponds to the corresponding checking point;
wherein when the memory reading unit completes reading the reference data of the search area and the pixel data of the macroblock, the error measures with respect to the checking points (0, 0), (STEP_SIZE, 0), (2×STEP_SIZE, 0), (0, STEP_SIZE), (STEP_SIZE, STEP_SIZE), (2×STEP_SIZE, STEP_SIZE), (0, 2×STEP_SIZE), (STEP_SIZE, 2×STEP_SIZE), and (2×STEP_SIZE, 2×STEP_SIZE) are obtained respectively.

4. A method for full-pel motion estimation, comprising the steps of:
(a) defining a macroblock of P by Q pixels with a starting point defined as C(0, 0) and defining a search area of L by J pixels with a starting point defined as R(0, 0), wherein L=2×STEP_SIZE+P, J=2×STEP_SIZE+Q;
(b) outputting reference data, denoted by DR(i, j), corresponding to a pixel R(i, j) of the search area, sequentially, line after line, from the starting point R(0, 0) to R(L−1, J−1) and outputting pixel data, denoted by DC(p, q), corresponding to a pixel C(p, q) of the macroblock, sequentially, line after line, from the starting point C(0, 0) to C(P−1, Q−1);
(c) while step (b) is performing, determining a plurality of error measures with respect to checking points (0, 0), (STEP-SIZE, 0), (2×STEP_SIZE, 0), (0, STEP_SIZE), (STEP_SIZE, STEP_SIZE), (2×STEP_SIZE, STEP_SIZE), (0, 2×STEP_SIZE), (STEP_SIZE, 2×STEP_SIZE), and (2×STEP_SIZE, 2×STEP_SIZE), respectively, the step (c) comprising:
if i<P and j<Q, in response to the reference data DR(i, j) and the pixel data DC(p, q), accumulatively calculating an error measure with respect to the checking point (0, 0) according to the pixel data DC(p, q) and the reference data DR(i, j);
if i>STEP_SIZE and i<(L+STEP_SIZE), and j<Q, in response to the reference data DR(i, j), and the pixel data DC(x1, y1) delayed for a time period corresponding to STEP_SIZE, where x1=i−STEP_SIZE and y1=j, accumulatively calculating an error measure with respect to the checking point (STEP_SIZE, 0) according to the delayed pixel data DC(x1, y1) and the reference data DR(i, j);
if i≧2×STEP_SIZE and i≦(L+2×STEP_SIZE), and j<Q, in response to the reference data DR(i, j), and the pixel data DC(x2, y2) delayed for a time period corresponding to 2×STEP_SIZE, where x2=i−2×STEP_SIZE and y2=j, accumulatively calculating an error measure with respect to the checking point (2×STEP_SIZE, 0) according to the delayed pixel data DC(x2, y2) and the reference data R(i, j); if i<P and j≧STEP_SIZE and j<(L+STEP_SIZE), in response to the reference data DR(i, j), and the pixel data DC(x3, y3) delayed for a time period corresponding to P×STEP_SIZE, where x3=i and y3=j−P×STEP_SIZE, accumulatively calculating an error measure with respect to the checking point (0, STEP_SIZE) according to the delayed pixel data DC(x3, y3) and the reference data DR(i, j);
if i≧STEP_SIZE and i<(L+STEP_SIZE) and j≧STEP_SIZE and j<(L+STEP_SIZE), in response to the reference data DR(i, j), and the pixel data DC(x4, y4) delayed for a time period corresponding to (1+P)×STEP_SIZE, where x4=i−STEP_SIZE and y4=j−P×STEP_SIZE, accumulatively calculating an error measure with respect to the checking point (STEP_SIZE, STEP_SIZE) according to the delayed pixel data DC(x4, y4) and the reference data R(i, j);
if i≧2×STEP_SIZE and i<(L+2×STEP_SIZE) and j≧STEP_SIZE and j<(L+STEP_SIZE), in response to the reference data DR(i, j), and the pixel data DC(x5, y5) delayed for a time period corresponding to (2+P)×STEP_SIZE, where x5=i−2×STEP_SIZE and y5=j−P×STEP_SIZE, accumulatively calculating an error measure with respect to the checking point (2×STEP_SIZE, STEP_SIZE) according to the delayed pixel data DC(x5, y5) and the reference data DR(i, j);
if i<P and j≧2×STEP_SIZE and j<(L+2×STEP_SIZE), in response to the pixel data DC(x6, y6) delayed for a time period corresponding to 2×P×STEP_SIZE and the reference data DR(i, j), where x6=i and y6=j−2×P×STEP_SIZE, accumulatively calculating an error measure with respect to the checking point (0, 2×STEP_SIZE) according to the delayed pixel data DC(x6, y6) and the reference data R(i, j);
if i≧STEP_SIZE and i<(L+STEP_SIZE) and j≧2×STEP_SIZE and j<(L+2×STEP_SIZE), in response to the reference data DR(i, j), and the pixel data DC(x7, y7) delayed for a time period corresponding to (1+2×P)×STEP_SIZE, where x7=i−STEP_SIZE and y7=j−2×P×STEP_SIZE, accumulatively calculating an error measure with respect to the checking point (STEP_SIZE, 2×STEP_SIZE) according to the delayed pixel data DC(x7, y7) and the reference data R(i, j); and
if i≧2×STEP_SIZE and i<(L+2×STEP_SIZE) and j≧2×STEP_SIZE and j<(L+2×STEP_SIZE), in response to the reference data DR(i, j), and the pixel data DC(x8, y8) delayed for a time period corresponding to (2+2×P)×STEP_SIZE, where x8=i−2×STEP_SIZE and y8=j−2×P×STEP_SIZE, accumulatively calculating an error measure with respect to the checking point (2×STEP_SIZE, 2×STEP_SIZE) according to the delayed pixel data DC(x8, y8) and the reference data DR(i, j);
wherein when the step (b) is completed, the error measures, determined by the step (c), with respect to checking points (0, 0), (STEP_SIZE, 0), (2×STEP_SIZE, 0), (0, STEP_SIZE), (STEP_SIZE, STEP_SIZE), (2×STEP_SIZE, STEP_SIZE), (0, 2×STEP_SIZE), (STEP_SIZE, 2×STEP_SIZE), and (2×STEP_SIZE, 2×STEP_SIZE) are completed.

5. The method for full-pel motion estimation according to claim 4, wherein a minimum block distortion measure (DBM) point for a step in four step search algorithm can be determined according to the error measures corresponding to the checking points, wherein for the first, second, third, and fourth steps of four step search algorithm, the STEP_SIZE is set to 2, 2, 2, and 1 respectively.

6. The method for full-pel motion estimation according to claim 4, wherein a minimum block distortion measure (BDM) point for a step in 3-3-3-1 search algorithm can be determined according to the error measures corresponding to the checking points, wherein for the first, second, third, and fourth steps of 3-3-3-1 search algorithm, the STEP_SIZE is set to 3, 3, 3, and 1 respectively.

7. The method for full-pel motion estimation according to claim 4, wherein a minimum block distortion measure (BDM) point for a step in three step search algorithm can be determined according to the error measures corresponding to the checking points, wherein for the first, second, and third steps of three step search algorithm, the STEP_SIZE is set to 4, 2, and 1 respectively.

8. A method for full-pel motion estimation, comprising the steps of:
(a) defining a macroblock of M by N pixels with a starting point defined as MB(0, 0) and defining a search area of L by J pixels with a starting point defined as SA(0, 0), wherein L>P and J>Q;
(b) defining the search area into a subset of sub-areas of M by N pixels, associated with a plurality of checking points respectively, each sub-area in the subset of sub-areas having a starting point defined as the respective checking point;
(c) reading pixel data corresponding to pixels of the search area sequentially, line after line, from the starting point SA(0, 0) to SA(L−1, J−1), and reading pixel data corresponding to pixels of the macroblock sequentially, line after line, from the starting point MB(0, 0) to MB(M−1, N−1);
(d) while step (c) is performing, in response to pixel data corresponding to a pixel of the macroblock and being read by step (c), applying the pixel data to a delay unit array which outputs a plurality of flows of output data associated with the checking points, respectively, wherein for one of the checking points, C(x, y), a corresponding one of the flows of output data is outputted by the delay unit array, and the flow of output data is pixel data which has been delayed for a delay time of x+y×M time units;
(e) while step (c) is performing, in response to the pixel data corresponding to a pixel of the search area, SA(p, q), and being read by step (c), performing the steps of:
determining which sub-area in the subset of sub-areas includes SA(p, q); and
for each sub-area that includes SA(p, q), accumulatively calculating an error measure with respect to the checking point, C(f, g), which is associated with the sub-area according to pixel data which is from a flow of output data associated with the checking point C(f, g) and the pixel data corresponding to the pixel SA(p, q) of the search area, wherein the pixel data from the flow of output data associated with the checking point C(f, g) corresponds to a pixel of the macroblock, MB(r, s), where p=r+f and q=s+g;
wherein when the step (c) is completed, the error measures with respect to all of the checking points determined in the step (e) are completed.

9. An apparatus for half-pel motion estimation, wherein a macroblock of P by Q pixels with a starting point defined as C(0, 0) and a search area of L by J pixels with a starting point defined as R(0, 0) are defined, where L=2+P, J=2+Q, the apparatus comprising:
a half-pel values generation unit, in response to full-pel values sequentially read from the search area, for generating groups of four half-pel values, denoted by A, B, C, D, group by group;
a processing element (PE) array unit comprising:
a delay unit array comprising:
a plurality of horizontal delay units (HDUs) having 3 rows of HDUs, each row having a first HDU and a second HDU, each HDU including an input terminal and an output terminal, wherein in each row, the output terminal of the first HDU is connected to the input terminal of the second HDU; and
a plurality of vertical delay units (VDUs) having a first VDU and a second VDU, each having an input terminal and an output terminal, wherein the input terminal of the first VDU is connected to the input terminal of the first HDU of the first row, the output terminal of the first VDU is connected to the input terminal of the first hdu of the second row and the input terminal of the second VDU, the output terminal of the second VDU is connected to the input terminal of the first HDU of the third row;
and
a processing element (PE) array having 3 rows of processing elements (PEs), each row having first, second, and third PEs, each PE including a first input terminal and a second input terminal, an error measure output terminal, and a control terminal, wherein in each row, the second input terminal of the first PE is connected to the input terminal of the first HDU, the second input terminal of the second PE is connected to the output terminal of the first HDU, the second input terminal of the third PE is connected to the output terminal of the second HDU, wherein each PE calculates an error measure accumulatively between reference data at the first input terminal and pixel data at the second input terminal when the control terminal is enabled.
wherein for each group of four half-pel values, A is fed into the first input terminals of the first and third PEs of the first and third rows of the PE array; B is fed into the first input terminals of the second PE of the first and third rows of the PE array; C is fed into the first input terminals of the first and third PEs of the second row of the PE array; and D is fed into the first input terminal of the second PE of the second row of the PE array.

10. The apparatus for half-pel motion estimation according to claim 9, wherein the half-pel values generation unit comprises:
a preparation delay unit for providing groups of four full-pel values in parallel when receiving the full-pel values sequentially; and
a half-pel generating circuit for converting, group by group, the groups of four full-pel values into the groups of four half-pel values.

11. The apparatus for half-pel motion estimation according to claim 9, wherein the apparatus further comprises:
a memory reading unit for reading reference data, denoted by DR(i, j), corresponding to a pixel R(i, j) of the search area, sequentially, line after line, from the starting point R(0, 0) to R(L−1, J−1) and outputting pixel data, denoted by DC(p, q), corresponding to a pixel C(p, q) of the macroblock, sequentially, line after line, from the starting point C(0, 0) to C(P−1, Q−1);
wherein the pixel data DC(p, q) read by the memory reading unit is applied to the input terminal of the HDU of the first row, and the reference data DR(i, j) read by the memory reading unit is applied to the half-pel values generation unit.
